(19) United States
(12) Patent Application Publication
(10) Pub. No.: US 2005/0197993 A1
(43) Pub. Date: Sep. 8, 2005

(54) Network global expectation model for multi-tier networks

(75) Inventor: Steven K. Korotky, Toms River, NJ (US)

Correspondence Address: MOSER, PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/095,399

(22) Filed: Mar. 31, 2005

Related U.S. Application Data
(63) Continuation-in-part of application No. 10/661,747, filed on Sep. 12, 2003.

(51) Int. Cl. G06N 7/02

(52) U.S. Cl. 706/52

(57) ABSTRACT

In the Network Global Expectation Model, expectation values evaluated over the entire network are used as a multi-moment description of the required quantities of key network and network element (NE) resources and commensurate network costs. The Network Global Expectation Model naturally and analytically connects the global (network) and local (network element) views of the communication system, and thereby may be used as a tool to gain insight and very quickly provide approximate results for the preliminary evaluation and design of dynamic networks. Further, the Network Global Expectation Model may serve as a valuable guide in the areas of network element feature requirements, costs, sensitivity analyses, scaling performance, comparisons, product definition and application domains, and product and technology roadmapping. The network is arranged as a multiple tier network of nodes in order to apply the analysis methods of the Network Global Expectation Model. The analytical method is developed to include non-uniform demands on the network.

### CROSS-REFERENCE TO RELATED APPLICATION

This application is a continuation-in-part of commonly owned U.S. patent application Ser. No. 10/661,747 filed on Sep. 12, 2003 by this inventor (Attorney Docket No. LCNT/125465 (Korotky 28)).

### FIELD OF THE INVENTION

This invention relates to the field of optical networks and more specifically, to a method for rapidly quantifying the needs and costs of such optical networks.

### BACKGROUND OF THE INVENTION

Fundamental to the design, comparison, and selection of architectures for communication networks are the costs for building and operating the network to realize the desired capability and performance. These costs include the expenses for capital equipment (CAPEX), network operation (OPEX), and network management (MANEX). In order to evaluate the capital and operational costs of prospective architectures and technologies, it is usually necessary to establish system requirements on the quantity and capacity of the constituent components, or network elements, in the proposed system architecture. Many different approaches for analyzing and designing networks have been formulated, and in the case of optical networks these include detailed routing simulations and cost modeling, as well as analytical, statistical, and semi-empirical analyses. See, for example, A. Dwivedi et al., “Traffic model for USA long-distance optical network,” in Proc. Conf. Optical Fiber Commun., paper TuK1, pp. 156-158 (2000); S. Baroni et al., “Backbone network architectures for IP optical networking,” in Proc. Conf. Optical Fiber Commun., paper TuK2, pp. 159-161 (2000); C. Fenger et al., “Statistical study of the influence of topology on wavelength usage in WDM networks,” in Proc. Conf. Optical Fiber Commun., paper TuK6, pp. 171-173, (2000); A. S. Acampora et al., “On tolerating single link, double link, and nodal failures in symmetric grid networks”, J. High Speed Networks, Vol. 11, pp. 23-44 (2002); A. A. M. Saleh, “All-optical networking in metro, regional, and backbone networks,” in Dig. IEEE/LEOS Summer Top. Meet., paper MG3, p. 15 (2002); X. P. Ferreira et al., “Optical networks and the future of broadband services,” J. Technological Forecasting and Social Change, 69, pp. 741-758 (2002); A. Richter et al., “Impact of traffic topology on wavelength demand in wavelength routed optical networks,” in Proc. Conf. Optical Fiber Commun., paper ThH4, pp. 484-485 (2003); J. F. Labourdette et al., “Fast approximate dimensioning and performance analysis of mesh optical networks,” in Proc. Design Reliable Commun. Networks, pp. 428-439 (2003); and R. Parthiban et al., “Waveband grooming and IP aggregation in optical networks,” J. Lightwave Technol., Vol. 21, pp. 2476-2488 (2003).

The network analysis and optimization problem that is common to these different approaches is structured as a set of inputs, a capacity optimization, and a set of outputs. However, like the networks themselves, the models may be distinguished by their computational requirements, their scalability, and the type and quality of the output that they provide.

Network analysis carried out via numerical simulation often takes as input the network graph, a detailed set of demands, and a list of network elements together with their respective costs. The capacity optimization problem is often solved using linear programming techniques. The output of the analyses consists of the route chosen for each demand, the quantities and locations of the equipment to be deployed, and the total network cost. The numerical simulations provide detailed routing information for the demands; however, they are often computationally intensive. As a result, the simulations are limited in scalability and relatively slow. Therefore, a model method is needed for very quickly gauging the network equipment needs and costs.

### SUMMARY OF THE INVENTION

A scalable, systematic, and analytic approach for rapidly determining the needs and costs of mesh networks is achieved by utilizing expectation values evaluated over the entire network. This analytic approach has been called a Network Global Expectation Model. Inputs for this Network Global Expectation Model are graph variables, demand variables, and cost structures. The model makes use of analytic representations of near optimal solutions to the routing problem and capacity minimization. Among the outputs of this model are estimates of the quantities and variances of the network elements and the respective capacities, and the total network cost. By exchanging detailed knowledge of the routing of individual demands and the placement of resources within the network for statistical loading information, the model provides acceptable accuracy, is computationally-light, permits scaling to arbitrary network size, and produces very fast results. As presented in the above-identified patent application, the initial application of the Network Global Expectation Model was to single-tier networks of peer nodes.

Networks are also often organized in or partitioned into tiers to provide a convenient framework for the optimization, graceful growth, and evolution of the network. The present invention extends the Network Global Expectation Model to a multi-tier network. Particular emphasis is placed on application of the model to a two-tier description of the network. The present invention permits potential tradeoffs and comparisons among the choices in the relative division of the network between the multiple tiers to be evaluated quickly and with very modest computational resources.

The present invention provides a Network Global Expectation Model for estimating the network requirements and costs of communication networks using analytic formulae including expectation values measured over the entire network. The Network Global Expectation Model includes the calculation of the mean value, variance, and co-variance of all key network quantities and may be applied to a wide range of topologies, architectures, and demand profiles.

The Network Global Expectation Model of the present invention uses expectation values as a multi-moment description of the required quantities of key network and network element (NE) resources and commensurate network costs. This approach naturally, analytically, and accurately connects the global (network) and local (network element) views of the communication system. As a result, the model may be used as a tool to gain insight and quickly provide approximate results for preliminary network evaluation and design, element feature requirements, costs, sensitivity analyses, scaling performance, comparisons, product definition and application domains, and product and technology road-mapping.

The Network Global Expectation Model of the present invention is adaptable to both increasing and decreasing levels of detail and sophistication of the cost structures. Because of the analytic nature of the model the estimates of quantities may be computed much faster than is possible with detailed routing solvers, and so the model is ideally suited to network analyses in dynamic operating and technological environments. The uncomplicated and transparent accounting of network elements, systems, and costs inherent in the Network Global Expectation Model of the present invention constitutes a framework for the cooperative exchange of critical planning information on evolving network needs across the many sectors of the communication business.

The present invention also permits the analytic Network Global Expectation Model to treat non-uniform demand straightforwardly within the statistical framework of the global expectation model by explicitly considering population-dependent, location-independent demand.

The principles of the present invention are applicable to a wide variety of networks including access, metro, and long-distance. For specificity, the application of the general methodology is demonstrated with respect to long-haul, fiber-optic transport networks.

### BRIEF DESCRIPTION OF THE DRAWINGS

The teachings of the present invention can be readily understood by considering the following detailed description in conjunction with the accompanying drawings, in which:

FIG. 1 depicts a high level abstract representation of a mesh network wherein an embodiment of the present invention may be applied;

FIG. 2 depicts a high level representation of a prototypical backbone network wherein an embodiment of the present invention may be applied;

FIG. 3a depicts a high level block diagram of an exemplary cross-connect and line system arranged to illustrate five two-way ports (North, South, East, West, and Termination) service by a cross-connect wherein an embodiment of the present invention may be applied;

FIG. 3b depicts a high level block diagram of the system of FIG. 3a arranged to illustrate five one-way ports (five inputs and five outputs);

FIG. 4 graphically depicts a plot of the termination-to-termination traffic, r, for uniform demand as a function of the number of nodes, N, and total network traffic, T.

FIG. 5 graphically depicts a plot of the mean traffic on a link including idle restoration channels for uniform demand as a function of the number of nodes N and total network traffic T;

FIG. 6 depicts a high level block diagram of two cross-connect ports and the relationship among the local ADD, DROP and THRU channels;

FIG. 7 depicts a high level block diagram of an exemplary Bandwidth Management Architecture using both optical and electronic cross-connects;

FIG. 8 graphically depicts an illustrative comparison of bandwidth management costs;

FIG. 9 graphically depicts a contour map of the total cost of a mesh network with uniform demand as a function of the number of nodes N and total traffic T;

FIG. 10 depicts a high level representation of a prototypical backbone network organized into two tiers wherein an embodiment of the present invention may be applied; and

FIG. 11 graphically depicts a ratio of transmission costs versus the number of core nodes for the network.

### DETAILED DESCRIPTION OF THE INVENTION

Although various embodiments of the present invention herein are being described with respect to various communication networks, such as backbone, fiber-optic transport networks and mesh networks, it should be noted that the specific communication networks are simply provided as exemplary environments wherein embodiments of the present invention may be applied and should not be treated as limiting the scope of the invention. It will be appreciated by those skilled in the art informed by the teachings of the present invention that the concepts of the present invention are applicable to substantially any network wherein it is desirable to quickly gauge the network equipment needs and costs in light of prescribed or desired network requirements.

A general formalism of the global network expectation model is developed and its application is first illustrated by considering single-tier backbone networks with location-independent traffic demands. While the methodology presented herein is very general, the exemplary application of the model is described throughout the specification in the context of mesh networks. Once the development of model as applied to the single tier network is completely explained, the current invention is presented for multi-tier networks. The exemplary network used in the description is a two-tiered version of the single tier network employed in the earlier part of the description.

In the following sections of this description, the presentation and formal derivation of the quantities for the key network variables is organized with the goal of being a logical, methodical, and serial development and calculation of independent and dependent variables. Throughout this detailed description, use is constantly made of the mean, variance, and covariance of the variables of the model. Headings are supplied throughout the description to guide the reader to the location of topics of interest.

A. Network Global Expectation Model—Single Tier Network

1. Total Network Cost

As the cost of a single tier network for a specified set of features is considered the metric for comparison of architectures and technologies, the total single tier network cost is exactly the sum of the costs of the constituent parts, or elements, of the network. This fundamental accounting of costs may be written mathematically according to Eq. 1, which follows:

$${C}_{T} ≡ {\sum }_{i} {c}_{i} , \qquad ( 1 )$$

wherein C_{T} is the total network cost and c; is the unit cost of the ith component. Throughout this description, the symbolic notation Σ indicates the summation over the various contributing terms and, in the case above, the individual cost of each component.

It is usual that there are many components of a given type used throughout the network, and these identical parts share a common cost. In this case using the associative, commutative, and distributive properties of the field of real numbers, Eq. 1 above may be rewritten as:

$${C}_{T} ≡ {\sum }_{i} {v}_{1} {c}_{1} , \qquad ( 2 )$$

where again C_{T} is the total network cost, vᵢ is the number of network elements of type i, and cᵢ is the corresponding unit cost of network element of type i.

Without loss of generality, it may be assumed that the technology and corresponding unit costs, cᵢ, of the network elements used to construct the network are known or given apriori. The challenge of network design is to determine the placement and number, vᵢ, of each of the network elements of each type that minimizes the total network cost under the constraint to service a specified traffic demand among the network terminations located at specific geographic locations. One strategy employed by the model is to estimate the product of the network element counts with their respective costs while satisfying the external constraints, and thereby to estimate the total network cost using Eq. 2 above, but without explicitly establishing knowledge of the placement of every individual component within the network.

The summation in Eq. 2 does not distinguish among the various categories of network elements, but considers each contributing type as effectively indivisible. Without changing the value of the sum, terms may be collected that are logically related to one another into a cost subtotal for larger categories of elements. Denoting a general set of categories as α, Eq. 2 may be rewritten as follows:

$${C}_{T} ≡ {\sum }_{a} {\sum }_{i} {v}_{i} ( α ) {c ( α )}_{i} \qquad ( 3 )$$

One useful subdivision for separating costs is based on collecting the costs for signal transmission (TRANS) and signal bandwidth management (BWM) into separate terms. In this case Eq. 3 above may be rewritten as follows:

$${C}_{T} ≡ {\sum }_{TRANS} {v}_{i} {c}_{i} + {\sum }_{BWM} {v}_{j} {c}_{j} \qquad ( 4 )$$

The transmission term can include, for example, equipment such as optical transceivers (OT), optical multiplexers (OMUX), and optical amplifiers (OA). The bandwidth management term can include equipment such as multi-service platforms (MSP), electronic cross-connects (EXC), optical add/drop multiplexers (OADM), and optical cross-connects (OXC). Of course, the particular equipment associated with a category is a matter of architectural choice for the network.

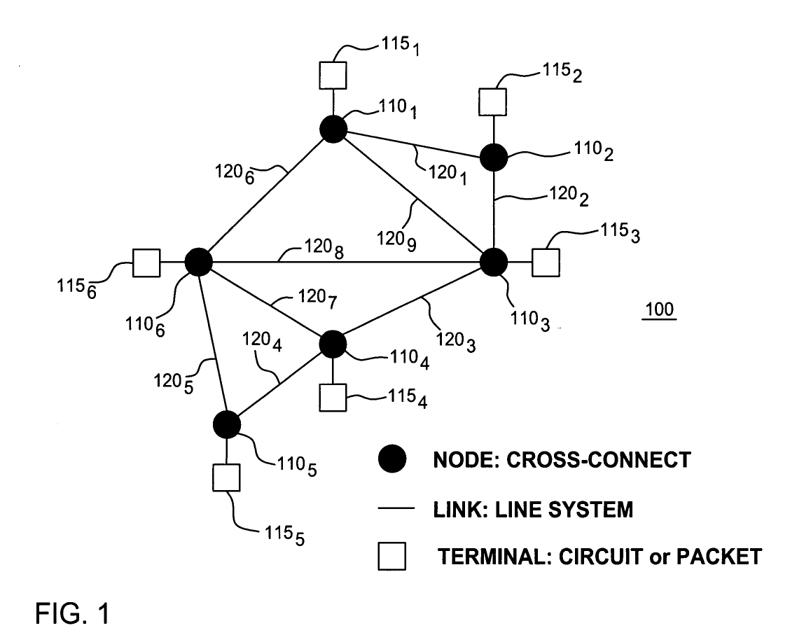

FIG. 1 depicts a high level abstract representation of a mesh network wherein an embodiment of the Network Global Expectation Model may be applied. The exemplary single tier mesh network 100 of FIG. 1 comprises a plurality of nodes 110₁-110₆ (collectively, nodes 110), where traffic may enter and leave the mesh network 100, a plurality of terminals 115₁-115₆ (collectively, terminals 115) connected to the nodes 110, which are the sources and sinks of traffic in the network 100, and a plurality of inter-nodal links 120₁-120₉ (collectively, links 120), which represent the physical segments over which the network traffic may be carried between the nodes 110. The total number of nodes and links of the mesh network 100 of FIG. 1 are denoted generally by variables N and L, respectively. The average degree of nodes in the mesh network 100 of FIG. 1 is [symbol] δ [symbol] =3 for N=6 nodes and L=9 links. The term “degree of a node” is defined hereinbelow with reference to Eqs. 13.

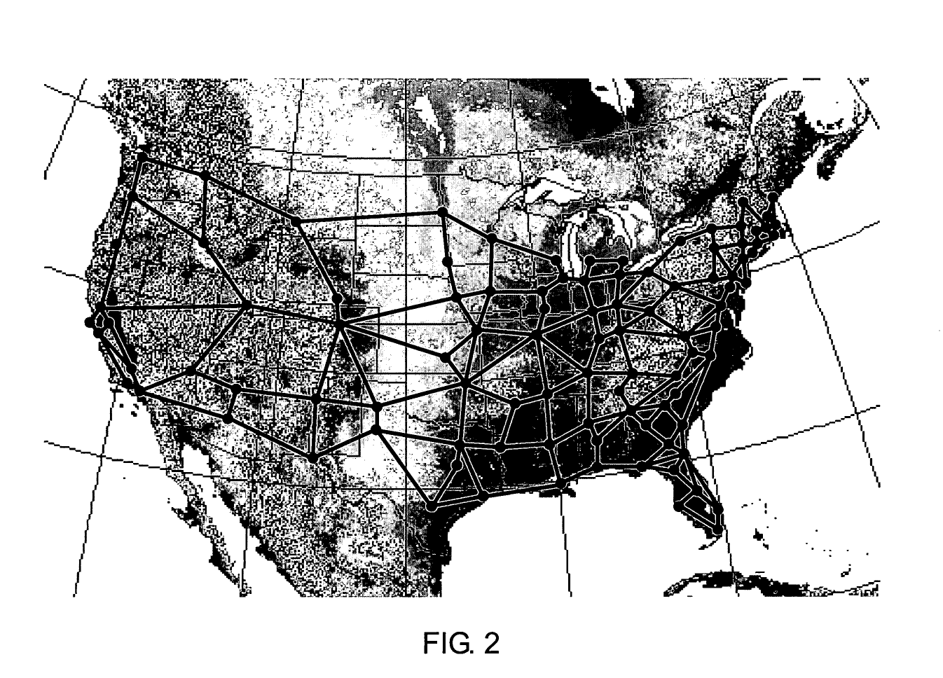

FIG. 2 depicts a map of the United States of America comprising an illustration of an exemplary single tier mesh network, such as the mesh network 100 of FIG. 1. FIG. 2 depicts a core fiber transport network typical of networks employed by large inter-exchange carriers in the continental United States. The exemplary network 200 of FIG. 2 illustratively comprises 100 nodes and 171 links. The average degree of each node is [symbol] δ [symbol] =3.4, and the average number of minimum hops between node pairs is [symbol] h [symbol] =6.6. This term is defined hereinbelow with reference to Eqs. 14.

As applied to the single tier networks illustrated in FIGS. 1 and 2, the total network cost, C_{T}, may also be represented in terms of the L links and N nodes of the network according to either of the following equations:

$$\begin{matrix}{C}_{T} ≡ {\sum }_{l}^{L} {c}_{l} + {\sum }_{n}^{N} {c}_{n} & ( 5 ) \\ {C}_{T} ≡ {\sum }_{LINKS} {c}_{l} + {\sum }_{NODES} {c}_{n} & ( 6 )\end{matrix}$$

where cₗ is the cost of the lth link and cₙ is the cost of the nth node.

As shown below for convenience, the average or expectation value, [symbol] q [symbol] , of a set of values {qᵢ} for i=1, . . . , m is defined as follows:

$$〈 q 〉 ≡ \frac{1}{m} {\sum }_{i}^{m} {q}_{i} \qquad ( 7 )$$

Throughout this specification, the bracket notation, [symbol] [symbol] , is used to denote the expectation value of a specified variable. In instances where the corresponding set {q} of an expectation value [symbol] q [symbol] may be ambiguous, the right bracket of the expectation value is followed by a subscript to provide clarification. Also regarding expectation values, the elements qᵢ of the set {q} are not samples of a variable associated with either a discrete or continuous probability distribution, but rather they define a distribution.

When the first and second terms in Eq. 5 are multiplied by the factors L/L and N/N respectively, Eq. 5 can be rewritten as follows:
C_{T}=Lcₗ+Ncₙ [symbol] (8)
Thus, the exact cost of the network is the sum of the expectation value of the cost of the links times the number of links and the expectation value of the cost of the nodes times the number of nodes. The global expectation values cₗ and cₙ are themselves explicitly defined as follows:

$$\begin{matrix}〈 {c}_{l} 〉 = {\sum }_{i} {〈 {v}_{i} 〉}_{l} {c}_{i} & ( 9 a ) \\ 〈 {c}_{n} 〉 = {\sum }_{j} {〈 {v}_{j} 〉}_{n} {c}_{j} & ( 9 b )\end{matrix}$$

In Eq. 9a, [symbol] vᵢ [symbol] ₗ indicates an expectation value over the set of links {l} and in Eq. 9b, [symbol] vⱼ [symbol] ₙ indicates an expectation value over the set of nodes {n}.

The relationship of network cost to link and node costs embodied in Eqs. 8 & 9 could serve as the starting point of the description of the Network Global Expectation Model, however, the description of the Network Global Expectation Model instead begins with Eq. 1 to establish firmly that the use of expectation values to determine the total network cost is not an approximation, but is exact. The approximations of the global expectation model reside in the estimation of the expectation values of the quantities of network elements, [symbol] v [symbol] . Consequently, the predictive capability of the model will depend upon the accuracy of the estimations of these mean values and the applicability of other related assumptions, such as demand. As will be demonstrated herein, the expectation values for many variables may be computed exactly from the input variables for a given demand model, while it is necessary to introduce semi-empirical approximations for other variables.

2. Network and Primary Model Variables

With reference to FIGS. 1 and 2, a communication network has been defined as the combination of a network graph G comprising a set of N nodes {nᵢ} and a set of L connecting two-way links or edges {lᵢ} and a network traffic. The network graph may be represented by the symmetric matrix [g] with elements gᵢⱼ. The pair-wise communication traffic between nodes may be represented by the symmetric demand matrix [d] with elements dᵢⱼ and the total ingress/egress traffic T.

The matrix elements gᵢⱼ are either 0 or 1 in value and specify whether a pair of nodes is connected via a physical link. The summation of all the values of the matrix elements of [g] yields the number of one-way links L₁, which is twice the number of two-way links, L₂.

The demand matrix elements dᵢⱼ are either zero or a positive integer and denote the magnitude of the termination-to-termination traffic in quantized units of some basic measure of communication bandwidth, such as a standardized channel bit-rate, B. The summation of all the values of the matrix elements of [d] yields the number of one-way demands D₁, which is twice the number of two-way demands D₂. It should be noted that, generally the diagonal elements of [g] and [d] are zero. The demands are also often referred to as logical links.

Often the channel bit-rate is not explicitly given for the network of interest. Instead, the total ingress/egress traffic T and number of demands are specified. In that case a value of the termination-to-termination (also called peer-to-peer) τ traffic must be deduced, and from this a logical value of B may be chosen. It is for this reason that here the total two-way traffic is considered T₂, which is one-half the total one-way traffic T₁, to be an independent variable and for τ to be a dependent variable. With T as an independent variable, a complete set of model inputs is obtained, namely, G(N,L), D, and T together with a demand model. All other variables of interest may be derived from these variables.

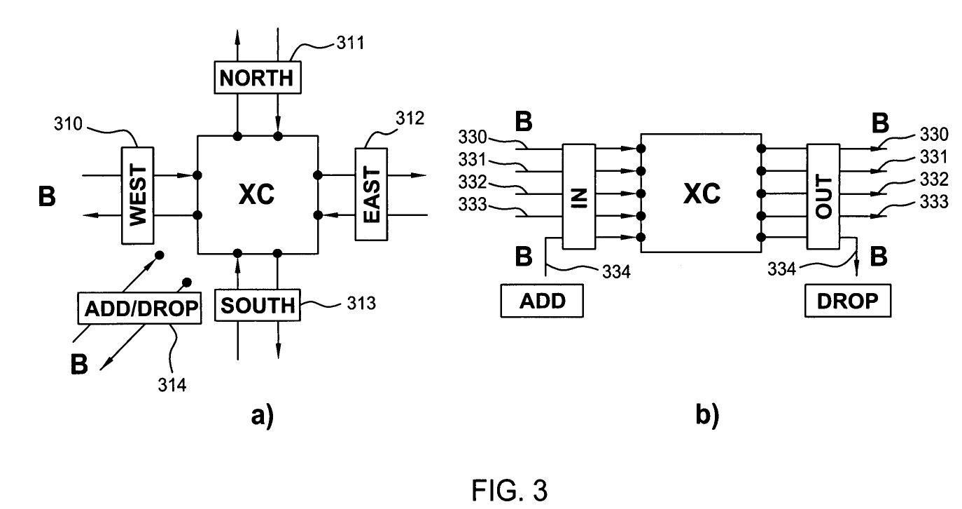

In counting quantities such as links, demands, traffic, etc. it is necessary to distinguish between one-way (simplex) and two-way (duplex) variables. As indicated above, the number of two-way links, demands, and traffic is one-half the corresponding number of one-way links, demands, and traffic, respectively. These relationships are illustrated in FIGS. 3a and 3b and are formally summarized as follows:
Links: L≡L₂=L₁/2 (10a)
Total Traffic: T≡T₂=T₁/2 (10b)
Total Demands: D≡D₂=D₁/2 (10c)

FIG. 3a depicts a high level block diagram of an exemplary single tier cross-connect and line system wherein the Network Global Expectation Model can be applied. The cross-connect and line system 300 of FIG. 3a illustratively comprises five two-way ports 310-314 (illustratively, North, South, East, West and Termination ports) serviced by the cross-connect 320.

FIG. 3b depicts a high level block diagram of the single tier cross-connect and line system 300 of FIG. 3a arranged to illustrate five one-way ports 330-334. There are five input ports and five output ports. It is typical to define a two-way channel of bandwidth B as the combination of two one-way channels, XY and YX, each of bandwidth B. That is, the single value B describes both the one-way and two-way channels. This is evident in the examples depicted in FIGS. 3a and 3b. Also, for the case of two nodes, N=2, and one two-way link, L=1, the total one-way traffic is T₁=2B, and the total two-way traffic is T=T₂=B. Of course, so long as one-way or two-way variables are used consistently or if the proper conversion is made, the results and conclusions will be are the same. For example, B=T₂/D₂=T₁/D₁. Referring back to FIG. 3a and FIG. 3b, it should be noted that the numbers of one-way and two-way ports are identical, i.e., P₁=P_{2.} Also, the channel bit-rate B, or alternatively the termination-to-termination traffic, τ, describes both the one-way and two-way traffic between terminating nodes.

There are many output variables that are determined by the Network Global Expectation Model in spite of the small number of inputs. Among the output variables are the termination-to-termination traffic rate and expectation values and variances for the degree of node, number of hops, wavelengths on a link, traffic on a link, restoration capacity, number of ports on a cross-connect, total capacity of a cross-connect, and percentage add/drop at a node. These expectation values and a cost model for the individual elements assist in the computation of the total network cost.

B. Single-Tier Networks with Uniform (Location-Independent) Demands

1. Expectation Values of Network Element Quantities

To explore the Network Global Expectation Model, a single-tier network consisting of a set of peer nodes and uniform, fully-connected inter-terminal demands is first considered. While this may seem restrictive, in fact the Network Global Expectation Model may be applied to a wide range of network topologies, architectures, and demand profiles. This will become evident as the expectation values and general relationships that are independent of the details of the topology, architecture, and demand are formulated and derived. Additionally, the specific results for uniform demand may also be useful in gauging key quantities for non-uniform demand profiles. For example, in the case of non-uniform demand that is not correlated with the absolute or relative location of terminal pairs (eg. random demand), uniform demand may be considered an average representation on the non-uniform demand. Also, one may envision restructuring an otherwise non-uniform network by grooming the traffic and truncating the set of nodes to produce a core network approaching the characteristics of a single-tier network with uniform demand.

Most core networks carry symmetric traffic between nodes, and so working with two-way variables is the norm. However, in some instances, visualizing and counting one-way variables may be more intuitive, such as tracking a one-way demand from source to destination. Of course, following two-way demands from termination to termination is equivalent. In the following, expressions will be explicitly developed using both one-way and two-way input variables for utmost clarity. In very many cases, the definition of output variables is such that the values do not change when switching between the one-way and two-way perspectives, as was previously illustrated.

Throughout the following, the model of the present invention will be applied to estimate key characteristics of two example networks. The first example network is the network 200 depicted in FIG. 2, which consists of 100 nodes and 171 links, uniform demand, and total two-way network traffic of 5 Tb/s. A second example network (not shown) is of similar topology and consists of 25 nodes and 42 links, uniform demand, and total two-way traffic of 1 Tb/s.

2. Number of Demands

The number of nodes, N, the total two-way traffic, T, and number of two-way links, L, are inputs of the model. The traffic demand is also an input of the model. The total number of demands is explicitly and, of course, straightforwardly related to the numbers of demands terminating at the individual nodes. The one-way demands terminating at node i may be related to the elements of the demand matrix [d], viz. dᵢ=Σ^{N}dᵢⱼ. By summing the terminating one-way demands, the total one-way and total two-way demands may be related to the mean terminating demands according to equations (11a) and 11(b), which follow:

$$\begin{matrix}{D}_{1} = {\sum }_{i}^{N} {d}_{i} = \frac{N}{N} {\sum }_{i}^{N} {d}_{i} = N {〈 d 〉}_{n} , and & ( 11 a ) \\ D ≡ {D}_{2} = {D}_{1} / 2 = \frac{1}{2} N {〈 d 〉}_{n} . & ( 11 b )\end{matrix}$$

The above expressions in Equations (11a) and (11b) are independent of the details of the demand model. The uniform demand model specifies that there is a one-way demand from every node to every other node, or a two-way demand between every node-node pair of the N nodes. Thus, the expression for uniform demand may be characterized according to equations (11c), (11d) and (11e), which follow: [symbol]
dₙ=N−1 (11c)
D₁=N(N−1) (11d)
D≡D₂=N(N−1)/2. (11e)
Using the equations above, the number of two-way demands may be calculated for the two example networks described above. For example, the number of two-way demands (logical links) for the example network 200 of FIG. 2 having N=100 nodes and L=171 physical links is D=4,950. The number of two-way demands for the second example network described above having N=25 nodes and L=42 links is D=300.
3. Termination-to-Termination Traffic

The value of the termination-to-termination traffic, τ, can be computed exactly as the ratio of the total ingress/egress traffic, T, and total number of two-way network demands, D, terminating at all nodes. As such, the value of termination-to-termination traffic, τ, may be characterized according to equations (12a) and (12b), which follow:
τ≡T₁/D₁=T₂/D₂ (12a)
and
τ≡T/[N(N−1)/2]. (12b)
where the latter equation characterizes the value for uniform (location independent) demand. The total traffic, T, and total number of demands, D, define the termination-to-termination traffic, τ, as indicated by the relationship expressed in Eq. 12a, which is independent of the demand model. As the total traffic and the number of demands define the termination-to-termination traffic, τ, the value of τis uniquely specified and as such its variance is exactly zero.

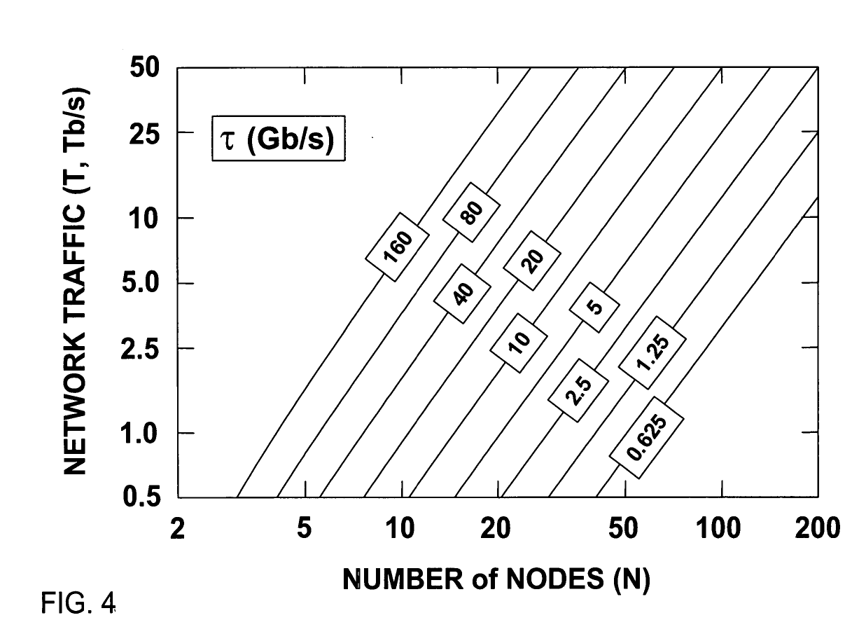

FIG. 4 graphically depicts a plot of the termination-to-termination traffic, τ, for uniform demand as a function of the number of nodes, N, and total network traffic, T. In FIG. 4, the termination-to-termination traffic, τ(N,T) for uniform demand is graphed as a function of the number of nodes, N, and total two-way traffic, T, using a contour plot. Contours of constant τ are labeled in units of Gb/s.

The termination-to-termination traffic, τ, for the example network 200 of FIG. 2 having N=100 nodes, t=171 links and total traffic of T=5 Tb/s is τ=1.01 Gb/s. This may be compared to τ=3.3 Gb/s for the example network having N=25 nodes, L=42 links, and total traffic of T=1 Tb/s. The channel bit-rate is smaller for the larger network because the number of demands for the larger network is significantly greater than for the smaller network.

4. Degree of Node

The average degree of a node, [symbol] δ [symbol] , (i.e. [symbol] δ [symbol] ₙ), is calculated straightforwardly by summing the number of one-way (directed) links and dividing by the number of nodes. Referring back to the matrix representation [g] of the network graph of FIG. 1 and FIG. 2, the average degree of node may be characterized according to equations (13a) and (13b), which follow:

$$\begin{matrix}{δ}_{i} = {\sum }_{j}^{N} {g}_{ij} \\ and so & ( 13 a ) \\ 〈 δ 〉 ≡ \frac{1}{N} {\sum }_{i}^{N} {\sum }_{j}^{N} {g}_{ij} = \frac{{L}_{1}}{N} = \frac{2 {L}_{2}}{N} = \frac{2 L}{N} & ( 13 b )\end{matrix}$$

This compact expression for (δ) is exact and independent of the demand model.

The variance σ²(q) and standard deviation σ(q) of the set of values for the network variable q, are characterized according to equations (13c) and (13d), which follow:

$${σ}^{2} ( q ) ≡ \frac{1}{m} {\sum }_{i}^{m} {( {q}_{i} - 〈 q 〉 )}^{2} \qquad ( 13 c )$$

which may be rewritten as
σ²(q)≡ [symbol] q²−q². (13d)
As previously noted, the set {q} is not a sampled data set, but defines the distribution. Furthermore, the standard deviation of a network variable is not an indication of the accuracy or error of the model, but rather it is a measure of the variation of the number of network elements or subsystems from locale to locale across the network. Note too that the value of the mean is independent of the variance. Thus, for example, the total cost for bandwidth management may be accurately predicted even while some nodes are smaller and cost less, and others are larger and cost more.

The variance of the degrees of nodes is defined according to Eq. 13e, which follows:
σ²(δ)≡ [symbol] δ² [symbol] − [symbol] δ [symbol] ², (13e)
and so like δᵢ and [symbol] δ [symbol] , σ²(δ) is a function only of the network graph, G. Note, however, unlike [symbol] δ [symbol] there is no closed form expression for σ²(δ) as a function only of N and L. Rather the variance of the degrees of nodes implicitly depends upon the details of the network connectivity and must be computed from a representation of the graph, such as [g] or an equivalent link-list. If the network graph, or equivalently the link-list, is provided then functions of the degrees of nodes, such as the variance, may be computed exactly.

As [symbol] δ [symbol] and L are directly proportional and the variance of δ is more closely related to [g], in some situations it may be useful to consider [symbol] δ [symbol] as the independent input variable and L as the dependent output variable.

For the example network 200 of FIG. 2 having N=100 nodes and L=171 links, the mean degree of node is [symbol] δ [symbol] =3.4. The standard deviation of the nodal degree obtained from the network graph (FIG. 2) is σ(δ)=1.1. By design, the mean degree of node and standard deviation of the nodal degree for the second example network having N=25 nodes and L=42 links are also [symbol] δ [symbol] =3.4 and σ(δ)=1.1.

5. Number of Hops

The number of hops between a pair of nodes is defined as the minimum number of inter-nodal links traversed by a demand between the terminating node pair. Algorithms for determining the minimum number of hops hᵢⱼ between node pairs (i,j) from the matrix representing the network graph [g] are well known, and so [h] and [symbol] h [symbol] may be readily computed given a demand model. The expectation value of the minimum number of hops is over the set of demands, (e.g., [symbol] h [symbol] _{d}), and may be characterized according to Eq. 14a, which follows:

$$〈 h 〉 = \frac{1}{D} {\sum }_{i < j}^{D} {h}_{i j} = \frac{1}{2 D} {\sum }_{i , j}^{D} {h}_{i j} \qquad ( 14 a )$$

If the network graph and demands are provided, then [symbol] h [symbol] may be computed exactly. However, [symbol] h [symbol] may also be approximated for uniform, location-independent, or random demands with knowledge only of the number of nodes and number of links, as will be discussed in more detail below.

The dependency of the average number of hops on the number of nodes N and number of links L may be formulated by considering the schematic of the network graph. If the outer boundary of the N nodes of a planar network arranged is visualized roughly as a square with √N nodes on each of the two orthogonal sides, the characteristic distance between nodes measured in units of hops scales as √N for uniform demand. In addition, the mean number of hops decreases as the number of links L increases for fixed N. An approximate analytic relationship describing the dependency of the mean number of hops on the number of nodes N and the mean degree of the nodes, [symbol] δ [symbol] , may be derived by considering a single node at the center of a regular network of constant degree, δ. In this case, the mean number of hops is approximately [symbol] h [symbol] ≅0.94√(N−1)/ [symbol] δ [symbol] ′. This expression slightly under predicts the correct result in the special case where each node is connected directly to every other node via a dedicated physical link (i.e. δ=N−1 and [symbol] h [symbol] ≡1). Brute force evaluation of the mean number of hops for regular networks of constant degree for δ=3 and δ=4, except for the nodes at the perimeter, yields [symbol] h [symbol] ≅1.2√N/ [symbol] δ [symbol] ′, which slightly over-predicts the means number of hops for the special case of δ=N−1 and [symbol] h [symbol] ≡1.

In order to provide accurate compact analytic expressions for all variables for a wide range of networks, the average number of hops of several prototypical networks that were designed to be survivable was analyzed under all possible single link failures. (Note, the failure of a single link implies the simultaneous failure of all demands appearing on the specified inter-nodal segment, which may be a very large number of demands.) This feature of network survivability translates into the requirement that the degrees of nodes for all nodes be greater than or equal to two (i.e., δ≧2). The exact results for the mean number of hops were fitted using the method of least squares deviation to determine the single coefficient of proportionality that best describes the data for all the networks considered. In total data for 14 mesh networks with numbers of nodes spanning the range 4≦N≦100 and average degree of node spanning the range 2.5≦(δ)≦5 were included. It was determined that the expectation value of the number of hops for these networks with uniform demand may be expressed semi-empirically by the relation of Eq. 14b, which follows: [symbol]
h≅1.12\sqrt{N/ [symbol] δ [symbol]} (14b)
with a standard deviation of approximately 10 percent, and more accurately by the relation [symbol]
h≅1.14\sqrt{(N−1) [symbol] δ [symbol]} (14c)
with a standard deviation of approximately 7 percent.

These approximate formulae may be applied to the case of uniform, location-independent, or random demand. For fixed network topology, it is expected for the average number of hops to decrease for distance dependent demand models that weigh shorter distance demands more heavily than longer distance demands.

The estimate of the mean number of hops for the example network 200 of FIG. 2 having N=100 nodes and L=171 links determined using Eq. 14c above is [symbol] h [symbol] ≅6.1, which may be compared to the actual mean of [symbol] h [symbol] =6.6. For the example network having N=25 nodes and L=42 links, the mean number of hops determined using Eq. 14c is approximately [symbol] h [symbol] ≅3.0.

The variance of the number of hops may be computed from [h] using Eq. 13; however, it is not necessary to compute σ²(h) explicitly for the analyses that follow. The range of hops extends from 1 to some maximum number H, which is often referred to as the diameter of the network.

6. Demands on Link

It is evident that as a demand dᵢⱼ is routed across the network between terminating nodes (i,j) that the demand occupies a unit of transmission capacity on each of the links connecting the nodes. The minimum number of links occupied by a demand is, of course, the minimum number of hops hᵢⱼ from node i to node j. Consequently, the average number of demands carried on a link in the absence of extra capacity for restoration may be characterized according to equations (15a) and (15b), which follow:

$$\begin{matrix}〈 {W}^{0} 〉 = \frac{1}{L} {\sum }_{l}^{L} {D}_{l} \cdot 1 = \frac{1}{L} {\sum }_{i , j}^{D} 1 \cdot {h}_{i j} \\ = \frac{1}{L} \frac{D}{ D} {\sum }_{i , u}^{D} {h}_{i j} = \frac{D {〈 h 〉}_{D}}{L}\end{matrix} \qquad ( 15 a )$$

which may be rewritten in the convenient form [symbol]
W⁰=dh/δ (15b)
using equations (11b) and (13b). The expression of Eq. 15b is exact and valid and independent of the demand model; however, the value of [symbol] h [symbol] is implicitly dependent upon the demand model, as discussed earlier. In the cases of uniform or random demand, if an approximation for [symbol] h [symbol] such as equations (14b) or (14c), is used to compute [symbol] W⁰ [symbol] , then of course the result is also approximate, and the relative error of [symbol] h [symbol] determines the relative error of [symbol] W⁰ [symbol] .

For uniform demand, the value for (d) in Eq. 15b) may be substituted to obtain Eq. 15c, which follows: [symbol]
W⁰ [symbol] =(N−1) [symbol] h/δ. (15c)
Using Eq. 15c, the mean number of channels carried on a link for the first example network 200 of FIG. 2 having N=100 nodes and L=171 links ( [symbol] δ [symbol] =3.4 and [symbol] h [symbol] ≅6.1) is estimated to be [symbol] W⁰ [symbol] ≅178. Similarly, the mean number of channels on a link for the second example network having N=25 nodes and L=42 links ( [symbol] δ [symbol] =3.4 and [symbol] h [symbol] ≅3.0) is estimated to be [symbol] W⁰ [symbol] ≅22.

As suggested by Eq. 15b, variations in the number of channels carried on the individual links of the network may arise from differences in the number of demands terminating at the nodes connected to the links, the degrees of the nodes connected to the link, and also the routing constraints and algorithms. Here the case of uniform demand is considered, and the fluctuations that may arise when the demands are routed across the network under the constraint of minimum hop routing are first considered. In general, for any pair of nodes there will be one or more routes of minimum number of hops between the nodes. Consequently, the variation in the number of channels carried on a link will depend upon the selection criteria for choosing from among the set of minimum hop routes, which are referred to as hop-degenerate routes. If it is assumed that the path is selected at random from the hop-degenerate routes, then the variance may be estimated using statistical methods. In particular, for the scenario just described, the distribution of the demands among the minimum hop routes is described by the binomial distribution. As such, an approximate expression for the variance of W^{o} is derived by considering random routing over paths of equal numbers of hops.

Referring back to equations (15a)-(15c) above, the mean value for the number of channels on a link for uniform two-way demand may be explicitly characterized according to Eq. 15d, which follows:

$$\begin{matrix}〈 {W}^{0} 〉 = \frac{1}{L} \frac{1}{ 2} {\sum }_{i}^{N} {\sum }_{j}^{N - 1} {h}_{i j} \\ = N ( N - 1 ) 〈 h 〉 / 2 L\end{matrix} \qquad ( 15 d )$$

For a given node pair (i,j), all the paths of minimum hops hᵢⱼ between them are considered, and lᵢⱼ is used to denote the total number of distinct links among the set of hop-degenerate routes. These distinct links are labeled using the subscript k and pₖ is used to denote the probability that a link is selected. By construction, the set of probabilities {pₖ} satisfies Eq. 15e, which follows:

$${h}_{i j} = {\sum }_{k}^{{l}_{i j}} {P}_{k} \qquad ( 15 e )$$

and consequently, pₖ≅hᵢⱼ/lᵢⱼ. As an example, consider an illustrative case when there are three (r=3) link-disjoint routes of four (h=4) (minimum) hops between a pair of nodes. In this case lᵢⱼ=r×h=3×4=12. As the paths are assumed to be disjoint, Eq. 15e may be used to solve for pₖ with the result pₖ=hᵢⱼ/lᵢⱼ=h/(rh)=1/r=1/3 for each link.

Substituting Eq. 15e into Eq. 15d results in Eq. 15f, which follows:

$$〈 {W}^{0} 〉 = \frac{1}{2 L} {\sum }_{i}^{N} {\sum }_{j}^{N - 1} {\sum }_{k}^{{l}_{i j}} {P}_{k} \qquad ( 15 f )$$

Using the properties of the binomial distribution, the corresponding variance σ²(Wₒ) may be characterized according to equations (15g) and (15h), which follow:

$${σ}^{2} 〈 {W}^{0} 〉 = \frac{1}{2 L} {\sum }_{i}^{N} {\sum }_{j}^{N - 1} {\sum }_{k}^{{l}_{i j}} {p}_{k} ( 1 - {p}_{k} ) \qquad ( 15 g )$$

using equations (15e) and (15f), Eq. 15g may be rewritten as

$${σ}^{2} ( {W}^{0} ) = 〈 {W}^{0} 〉 [ 1 - \frac{1}{N ( N - 1 ) 〈 h 〉} {\sum }_{i}^{N} {\sum }_{j}^{N - 1} {p}_{k}^{2} ] \qquad ( 15 h )$$

To evaluate the sums, the sum over the N−1 nodes is grouped into sets of constant numbers of hops, h. Let there be Nₕ nodes of h hops, and label each node by the index n. For each node the number of distinct links among the possible routes of h hops is denoted l_{n,h}. If H is the largest value of the set of minimum number of hops, then Eq. 15h may be rewritten according to Eq. 15i, which follows:

$${σ}^{2} ( {W}^{0} ) = 〈 {W}^{0} 〉 [ 1 - \frac{1}{〈 h 〉} \frac{1}{N} {\sum }_{i}^{N} \frac{1}{N - 1} {\sum }_{h}^{H} {\sum }_{n}^{{N}_{h}} {\sum }_{k}^{{l}_{n h}} {p}_{k}^{2} ] \qquad ( 15 i )$$

The above expression is exact under the assumption of uniform demand and random routing.

To carry this result further, an approximation for a planar network of average degree <δ> is derived. In this case the maximum number of hops H is characterized according to Eq. 15j, which follows:
N−1= [symbol] δ [symbol] [H(H+1)]/2, (15j)
and the value of H is related to [symbol] h [symbol] by H≅√2 [symbol] h [symbol] .

When focusing on a single node within the network, the nodes that may be reached in h minimum hops are identified as approximately [symbol] δ [symbol] h in number. The options for routing from the node under consideration to each of the other nodes h minimum hops away are subsequently considered. There is at least one possible route and the number of hop-degenerate routes are denoted as r. Next, the number of distinct links l_{n,h} among these r hop-degenerate routes are identified and counted. For the planar network, the number of distinct links l_{n,h} is less than h²; the latter being the number in the situation when the hop-degenerate routes are link-disjoint paths. Consequently, the probability any one link is selected when choosing a path randomly from among the hop-degenerate routes of the network is greater than 1/h, which may be characterized according to (15k), which follows:
pₖ≧1/h. (15k)
This expression for the probability that a link is selected permits the formal bounding of the variance of the number of channels. Substituting Eq. 15k) into Eq. 15i), carrying out the sums and using Eq. 15j) yields equations (15l) and (15m), which follow:

$$\begin{matrix}{σ}^{2} ( {W}^{o} ) \leq 〈 {W}^{0} 〉 [ 1 - 1 / 〈 h 〉 ] \\ and & ( 15 l ) \\ \frac{σ ( {W}^{0} )}{〈 {W}^{0} 〉} \leq \sqrt{1 - \frac{1}{〈 h 〉}} / \sqrt{〈 {W}^{0} 〉} \leq \frac{1}{\sqrt{〈 {W}^{0} 〉}} . & ( 15 m )\end{matrix}$$

The form of the variance in Eq. 15l) is that of a binomial distribution with probability 1/<h>. Thus, the actual distribution is approximated by the corresponding binomial distribution F(W=w), which is characterized according to equations (15n)-(15q), which follow:
F(W=w)=(wₘₐₓ|w)p^{w}(1−p)^{w}ₘₐₓ^{-w}, w=0, 1, . . . , wₘₐₓ (15n)
with p=1/ [symbol] h (15o)
wₘₐₓ≡W⁰h [symbol] , and (15p)
(wₘₐₓ|w)=wₘₐₓ!/[w!(wₘₐₓ−w)!]. (15q)
The binomial tail probability F(W≧w) may be determined using the incomplete beta function.

Using Eq. 15l, the standard deviation of the number of channels on a link for the example network 200 of FIG. 2 having N=100 nodes and L=171 links ( [symbol] δ [symbol] =3.4 and [symbol] h [symbol] ≅6.1) is estimated to be σ(W^{o})≦12. Recall the mean number of channels on a link was estimated to be [symbol] W^{o} [symbol] ≅178 for this network. Again using Eq. 15l, the standard deviation of the number of channels on a link for the example network 200 of FIG. 2 having network of N=25 nodes and L=42 links ( [symbol] δ [symbol] =3.4 and [symbol] h [symbol] ≅3.0) is estimated to be σ(W^{o})≦3.8. The mean number of channels on a link was estimated to be [symbol] W^{o} [symbol] ≅22 in this case.

In the above consideration of the variation of W^{o}, it should be understood that usually when traffic is routed and the network is optimized, paths are selected based on criteria such as the minimum number of hops, the shortest distance, or more generally the minimum cost. However, routing solutions that may be proven to be optimal are possible only for relatively small networks and, therefore, additional heuristic constraints are often imposed as strategies to ensure low cost. To minimize the cost of survivable networks, for example, algorithms to balance the traffic among the links are often introduced. By its definition, load-balancing deliberately seeks to dampen the variation of the number of channels carried on a link. Clearly if load-balancing is effective then the selection of paths from among the hop-degenerate routes is not random and σ(W^{o}) should be reduced relative to the value specified by Eq. 15l above. As a corollary, the ratio of the achieved variance to the value obtained for random routing is a measure of the success of the load-balancing algorithm.

The variance of the number of channels carried on a link derived above is a network global expectation based on routing decisions. A local view of the variations and the number of channels carried on a particular link (i,j) and their relationship to the terminating traffic and degrees of the local nodes may also be considered. A form for Wᵢⱼ based on Eq. 15b and an heuristic argument based upon the routed traffic may be developed. Eq. 15b may be written to identify the local traffic terminating at the nodes connected to the link (both ends) and the through traffic that passes by both nodes according to Eq. 15r, which follows: [symbol]
W⁰ [symbol] =2 [symbol] d/δ+d [symbol] ( [symbol] h−2)/ [symbol] δ [symbol] . (15r)
The first term corresponds to the division of the terminating traffic among the various links connected to the terminating nodes. Assuming minimum hop routing, to a good approximation the terminating traffic is equally distributed among all the links connected to the node. This implies a direct correlation of the first term of Eq. 15r to the local degrees of nodes connected to the link. The second term, however, corresponds to the many channels traversing the link that have destinations distributed across the entire network. For the moment it is considered that the traffic is routed to minimize the number of hops, but otherwise no preference among the individual links is imposed. Under these circumstances it is hypothesized that the second term has negligible correlation to the local degrees of nodes and is best described by a combination of the mean value and variations randomly distributed across the network. Therefore, the number of channels on a link may be characterized according to equations (15s) and (15t), which follow:
Wᵢⱼ=W_{B/E}+W_{B/T} (15s)
with
W_{B/E}≡dᵢ(1/δᵢ+1/δⱼ)−1. (15t)
(The right most “−1” in Eq. 15t ensures the proper accounting of the demand between node i and node j.) The variable W_{B/T} includes random variations in the number of through channels and satisfies Eq. 15u, which follows: [symbol]
W_{B/T}≡d [symbol] ( [symbol] h−2)/ [symbol] δ [symbol] +1. (15u)
The variance of W_{B/T} may be estimated using the statistical formalism described above with respect to Eq. 15l with W_{B/T} replacing W^{o} and [symbol] W_{B/T} [symbol] replacing [symbol] W^{o} [symbol] .

It can be verified by direct computation that the expectation value of W_{i,j} (equations 15s-15u) yields [symbol] W^{o} [symbol] (equation 15r) in the case of location-independent demand, as required. As the second term of equation 15r is locally uncorrelated with the first term, the variance of W^{o} may therefore be expressed according to Eq. 15v, which follows:
σ²(W^{o})≅(2/ [symbol] δ [symbol] )²σ²(d)+ [symbol] d²σ²(1/δ)+σ²⁽^{W}_{B/T}). (15v)
The variance associated with routing decisions implicitly assuming no variation in o has already been estimated using Eq. 15l. Now, the relative size of the variance in W^{o} attributable to variations in the degrees of the nodes may also be estimated. The variations correlated to the local degrees of nodes (i.e., the second term of Eq. 15v), may be computed directly from the network graph. For the present it should be noted that for uniform demand σ²(d) ≡0, and
σ(W_{B/E})/ [symbol] W_{B/E} [symbol] ≅\sqrt{[ [symbol] δ [symbol] ₙ [symbol] 1/δ [symbol] ₙ−1]/2} (15w)
Using equations (15t) and (15w), the mean and standard deviation of the number of A/D channels terminating at the two ends of a link are estimated to be [symbol] W_{B/E} [symbol] ≅58 and σ(W_{B/E})≦13, respectively, for the example network 200 of FIG. 2 having N=100 nodes and L=171 links ( [symbol] δ [symbol] =3.4, [symbol] h [symbol] ≅6.1, [symbol] 1/δ [symbol] =0.32). The mean number of channels not terminating at either end of a link is approximately [symbol] W_{B/T} [symbol] ≅120 for this network. For the smaller example network having N=25 nodes and L=42 links ( [symbol] δ [symbol] =3.4, [symbol] h [symbol] ≅3.0, [symbol] 1/δ [symbol] =0.32) the mean and standard deviation of the number of A/D channels terminating at the two ends of a link are estimated to be [symbol] W_{B/E} [symbol] ≅14 and σ(W_{B/E})≦2.8. The mean number of channels not terminating at either end of a link is approximately [symbol] W_{B/T} [symbol] =7.5 for this example.

If the terminating demands are not uniformly distributed, but instead randomly distributed, then the first term in Eq. 15v proportional to σ²(d) (i.e., σ_{d}²(W^{o})) also contributes to the variance of W^{o} according to Eq. 15x, which follows:
σ_{d}(W^{o})/ [symbol] W^{o} [symbol] =[2/ [symbol] h [symbol] ][(σ(d)/ [symbol] d]. (15x)
As previously stated, the expressions for [symbol] W^{o} [symbol] (equations (15b) and (15c)) are exact and independent of the estimations of σ(Wₒ).
7. Restoration Capacity

The additional capacity added to links to ensure network survivability depends upon the types of failures considered, the restoration strategy, and the blocking characteristics of the cross-connects used to redirect the affected traffic over alternate routes. For the purpose of architectural comparisons, network survivability is very often defined in relation to single link failures (i.e., the network is designed and minimally sufficient capacity is deployed to ensure the network can support the traffic and is survivable against all single link failures). As explained earlier, this implies the network has sufficient extra capacity to restore all of the simultaneously failed demands sharing the common failed link. Extra capacity is counted in units of additional channel-links and is most often reported as a fractional increase above the total number of channel-links for minimum hop routing. Using that convention, the average number of channels on a link including extra capacity for restoration may be characterized according to Eq. 16a, which follows: [symbol]
W^{κ}≡W^{o} [symbol] (1+ [symbol] κ [symbol] ). (16a)
The superscript designation κ is introduced to W to indicate that the expression accounts for extra capacity for restoration. This expression is independent of the demand model. In considering the individual failure of all the δᵢ+δⱼ−1 links that are connected to the two nodes at the ends of link (i,j), the number of channels on an individual link (i,j) including the extra capacity for restoration is characterized according to Eq. 16b, which follows:
W^{κ}ᵢⱼ=Wᵢⱼ+W^{o} [symbol] κᵢⱼ, (16b)
where Wᵢⱼ and [symbol] W^{o} [symbol] are given by equations (15t)-(15v) and Eq. 15s, respectively. The mean value of this model for W^{κ}ᵢⱼ yields Eq. 16a, as required. Below formulae are developed for [symbol] κ [symbol] and κᵢⱼ as functions of the input network variables.

Precisely determining the amount of additional capacity requires a detailed network analysis and a non-trivial exercise for large mesh networks. Obtaining exact results for general mesh networks when the number of nodes is more than about 20 is presently not practical because of the magnitude and duration of the numerical computations. Thus, some form of heuristic algorithm for routing traffic and assigning restoration capacity is usually employed for large networks.

In considering the extra capacity that must be deployed to ensure survivability against single link failures, a general inverse dependency upon the degree of the nodes is readily recognized and explained qualitatively. For example, a ring network (which by definition has an average degree of node equal to 2) with dedicated protection requires 100% extra capacity relative to the minimum capacity necessary to carry the traffic demand. As such, a qualitative relationship between the fractional increase in capacity on a link and the degree of the node to which the link is connected may be characterized according to Eq. 17a), which follows:
κ˜1/(δ−1). (17a)
However, a strict interpretation of Eq. 17a) as an equality can under-predict by one-third or more the necessary extra capacity for planar mesh networks when [symbol] δ [symbol] is greater than 2. To assess the feasibility of using an analytic equation to model the extra capacity, the extra capacity determined by detailed calculation and simulation of mesh networks with uniform demands has been fitted for the case of strictly non-blocking cross-connects using the expression: [symbol]
κ [symbol] =(a−b)/( [symbol] δ [symbol] −b), (17b)
where a and b are parameters to be determined semi-empirically.

The results for the extra capacity for 8 mesh networks are considered and the condition is also imposed that [symbol] κ [symbol] =1 for [symbol] δ [symbol] =2. The mesh networks had numbers of nodes N in the range of 4≦N≦100, average degree of node in the range of 2.5≦ [symbol] δ [symbol] ≦4.5, and required an average extra capacity in the range of 0.4≦ [symbol] κ [symbol] ≦0.9. The constraint to describe the ring network exactly using Eq. 17b requires a=2. The best value of b was then determined to be b=−0.4. Within the accuracy (σ≅±17%) of the fitted results, the functional form for the extra capacity may be characterized according to Eq. 17c, which follows: [symbol]
κ [symbol] ≅2/ [symbol] δ [symbol] . (17c)
The form of Eq. 17c for the required extra capacity in the case of single link failures suggests that only one-half of the links connected to a node in common with the failed link participate in carrying the rerouted traffic. This is understood qualitatively when it is considered that using the other one-half of the links would result in diverting the rerouted traffic further away from its intended destination and consequently over even longer paths, which may introduce increased signal impairments, such as longer latency and higher bit-error-rate, as well as the complexity of involving larger numbers of nodes. For completeness an expression is noted for the extra capacity on the individual links that results in the expectation value of the extra capacity given by Eq. 17c, which is characterized according to equations (17d) and (17e), which follow:

$$\begin{matrix}{κ}_{i j} = \frac{1}{2} [ 2 / {δ}_{i} + 2 / {δ}_{j} ] \\ and & ( 17 d ) \\ 〈 κ 〉 ≡ \frac{1}{L} {\sum }_{i , j}^{L} {κ}_{i j} ≅ \frac{1}{L} {\sum }_{i , j}^{L} ( \frac{1}{{δ}_{i}} + \frac{1}{{δ}_{j}} ) \\ = \frac{1}{L} {\sum }_{n}^{N} {\sum }_{k}^{{δ}_{n}} \frac{1}{{δ}_{n}} = \frac{N}{L} = \frac{2}{〈 δ 〉} & ( 17 e )\end{matrix}$$

or more explicitly [symbol] κ [symbol] ₗ=2/ [symbol] δ [symbol] ₙ. It should be noted however, that based on Eq. 17e, the property that [symbol] 1/δ [symbol] ₗ=1/ [symbol] δ [symbol] ₙ. However, in general, [symbol] 1/δ [symbol] ₙ≠1/ [symbol] δ [symbol] ₙ except for in regular networks of constant degree, δ, or as an approximation.

A slightly more accurate semi-empirical representation (σ≅±12%) of the values of the extra capacities of the networks considered is characterized according to equations (17f) and (17g), which follow: [symbol]
κ [symbol] ₗ= [symbol] 2/δ [symbol] ₙ, (17f)
for which the corresponding local extra capacity is
κᵢⱼ=½[(2/δᵢ)²+(2/δⱼ)²]/[2/ [symbol] δ [symbol] ]. (17g)
In both cases it is clear there is a strong correlation between the efficient use of spare capacity for survivability and the degrees of the nodes. Note too that the success of equations (17c)-(17g) in representing the required extra capacity also reinforces the postulation that the traffic load is relatively balanced on the individual links (i.e., Eq. 15b). It is also expected that the approximate analytic expressions for κ (e.g., equations (17)) hold independent of the demand model, as they were hypothesized based on the mesh topology of the network, and not explicitly upon the demand model. Finally, it is pointed out that the additional capacity required for dynamic networks, such as for survivable networks, will be larger if the cross-connects are not strictly non-blocking. For example, in the case of wavelength-division-multiplexed line systems and cross-connects without wavelength interchange except at the terminations, the increase of the extra capacity for restoration above the minimum value for strictly non-blocking cross-connects is typically in the range of only 5-20%, although the management complexity is greatly increased.

For the example network 200 of FIG. 2 having N=100 nodes and L=171 links ( [symbol] δ [symbol] =3.4), the mean value of the extra capacity to ensure survivability under single link failures is estimated to be [symbol] κ [symbol] ≅0.58. As the mean degree of node for the second example network having N=25 nodes and L=42 links is nearly identical to that of the larger network by design, [symbol] δ [symbol] ≅3.4, the estimate for the mean value of the extra capacity to ensure survivability under single link failures is also nearly the same at [symbol] κ [symbol] ≅0.60.

As described above, the extra capacity on individual links has been modeled in a manner that is both intuitive and consistent with empirical observations of the total extra capacity. The model for {κ} depends only upon the degrees of the nodes, {δ}, and consequently it is a function of the input network graph G, as stated explicitly in Eq. 13a.

8. Traffic on Link

The average traffic carried on a link [symbol] β [symbol] is the product of the average number of demands on a link [symbol] W [symbol] and the termination-to-termination traffic per demand τ, and is characterized according to Eq. 18a, which follows: [symbol]
β [symbol] ≡ [symbol] Wτ=τhD/L=hT/L. (18a)
This direct proportionality is independent of the demand model.

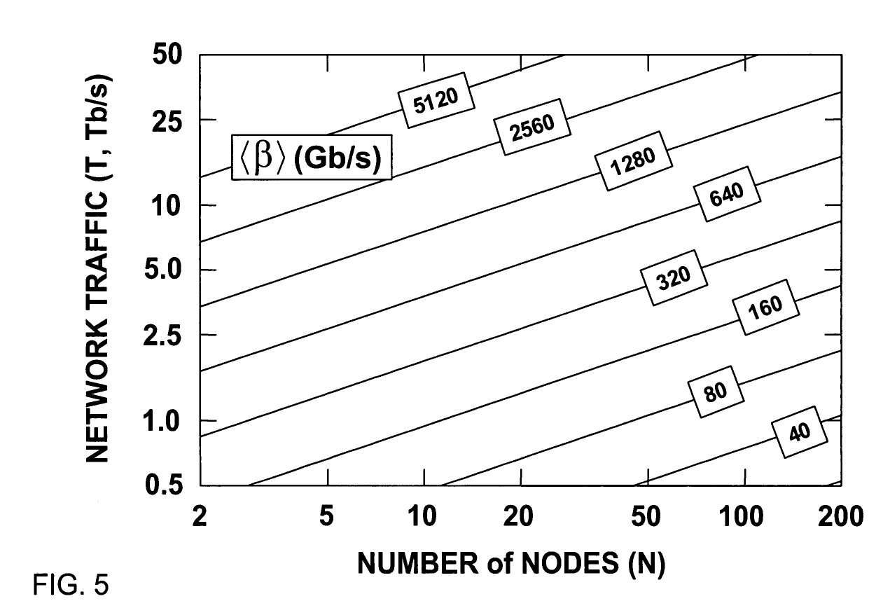

FIG. 5 graphically depicts a plot of the mean traffic on a link including idle restoration channels for uniform demand as a function of the number of nodes N and total network traffic T. In FIG. 5, the mean traffic on a link [symbol] β^{κ}(N, T) [symbol] for uniform demand with restoration is graphed as a function of the number of nodes N and total two-way traffic under the constraint [symbol] δ [symbol] =3.5 using a contour plot.

For the example network 200 of FIG. 2 having N=100 nodes, L=171 links, and T=5 Tb/s, the mean value of the traffic carried on a link including extra capacity for restoration is [symbol] β^{κ} [symbol] ≅284 Gb/s. In comparison, the mean value of the traffic carried on a link including extra capacity for restoration for the smaller example network having N=25 nodes, L=42 links, and T=1 Tb/s, is [symbol] β^{κ} [symbol] ≅116 Gb/s.

Based on the preceding discussions, it has been determined that the variance of β is determined by the variance of W and that the variances are related according to Eq. 18b, which follows:
σ(β)/ [symbol] β [symbol] =σ(W)/ [symbol] W. (18b)
9. Number of Ports and Capacity of a Cross-Connect

Among the key attributes of cross-connects are the port count, P, and total capacity, χ. The average number of ports on a cross-connect in a mesh network can be determined by counting the number of ports that each demand occupies as it traverses the network, tallying the number of ports for all demands, and then dividing by the number of cross-connects. By design a cross-connect—of which an add-drop multiplexer is considered a special case—is placed at each node of the backbone network to manage transport bandwidth, and so the number of cross-connects is given by the number of nodes, N.

As illustrated in FIG. 3, the number of output ports is usually equal to the number of inputs. Also, a P×P cross-connect, which has P inputs and P outputs (or P I/O ports), supports connections among P two-way channels.

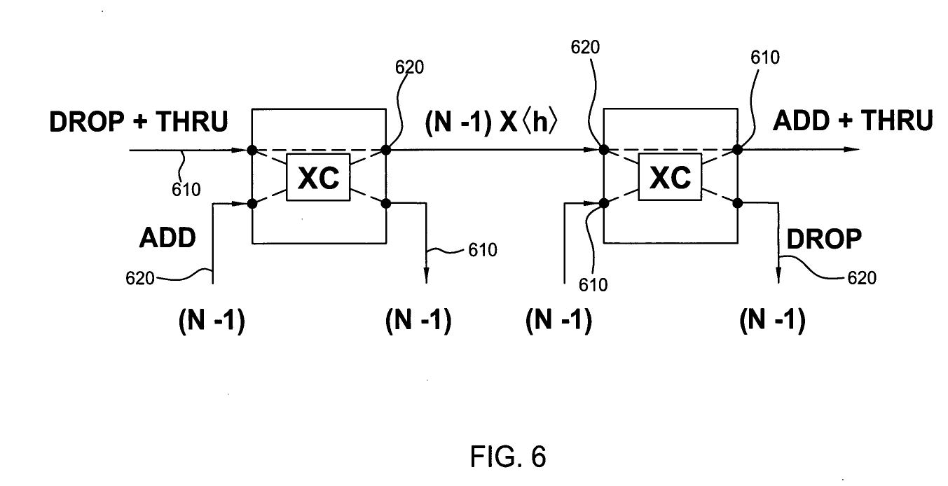

The average number of one-way input ports, P₁ is first calculated. FIG. 6 depicts a high level block diagram of two cross-connect ports 610, 620 and the relationship among the local ADD, DROP and THRU channels. FIG. 6 illustratively serves as a guide to counting the number of cross-connect ports occupied by a demand as it traverses a network. In FIG. 6, the numbers of add and drop demands, depicted as N−1, specifically correspond to the uniform demand model. Referring to FIG. 6, consider a directed demand that enters, or is added to, the network via the cross-connect of the node on the left. Adding the demand requires one input port. Eventually, this demand exits the network. Dropping from the network is accomplished by entering and exiting the cross-connect at the destination node, which may be considered the node on the right of FIG. 6. Thus, dropping the demand also requires one input port. Additionally, in traversing the network the demand under consideration occupies input ports at the cross-connects of the intervening nodes. Having defined “h” as the number of inter-terminal hops, the number of intervening cross-connects that the demand enters is h−1. Consequently, the number of input ports that a one-way demand occupies may be characterized according to Eq. 19a), which follows:
pᵢⱼ=1+1+(hᵢⱼ−1)=1+hᵢⱼ. (19a)
The total number of input ports occupied by all demands is therefore characterized according to Eq. 19b, which follows:

$${P}_{t} = {\sum }_{i , j}^{{D}_{1}} [ 1 + {h}_{ij} ] = \frac{{D}_{1}}{{D}_{1}} {\sum }_{i , j}^{{D}_{1}} [ 1 + {h}_{ij} ] = {D}_{1} 〈 1 + {h}_{ij} 〉 = N 〈 d 〉 [ 1 + 〈 h 〉 ] , \qquad ( 19 b )$$

and the average number of input ports [symbol] P₁ [symbol] occupied on a cross-connect at a node is characterized according to Eq. 19c, which follows: [symbol]
P₁ [symbol] =(D₁/N)[1+ [symbol] h]=d[1+ [symbol] h]. (19c)
Equations (19a)-(19c) are valid independent of the demand model; while as before the value of [symbol] h [symbol] is implicitly dependent upon the demand model. For the case of a mesh network with uniform demands, [symbol] d [symbol] in Eq. 19c is substituted using Eq. 11c to obtain Eq. 19d, which follows: [symbol]
P₁ [symbol] =(N−1)[1+ [symbol] h], (19d)
where [symbol] h [symbol] may be approximated using Eq. 14b or Eq. 14c.

For completeness, the average number of two-way ports for a cross-connect of the same network is computed. The number of two-way terminations for a two-way demand is 2, one at each terminus. The average number of two-way thru ports occupied is 2[1+ [symbol] h [symbol] ] and the total number of two-way ports occupied is characterized according to Eq. 19e), which follows:

$${P}_{t} = {\sum }_{i < j}^{{D}_{1}} [ 1 + {h}_{ij} ] = \frac{{D}_{2}}{{D}_{2}} {\sum }_{i < j}^{{D}_{2}} 2 [ 1 + {h}_{ij} ] = 2 {D}_{2} 〈 1 + {h}_{ij} 〉 = 2 {D}_{2} [ 1 + 〈 h 〉 ] \qquad ( 19 e )$$

Thus, the average number of two-way ports is characterized according to Eq. 19f, which follows: [symbol]
P₂ [symbol] =2(D₂/N)[1+ [symbol] h]. (19f)
By substituting for D₂ using Eq. 10c), it has been determined Eq. 20a, which follows: [symbol]
P [symbol] ≡ [symbol] P₂ [symbol] = [symbol] P₁ [symbol] , (20a)
which may be appreciated by again considering FIG. 3. This result is independent of the demand model and may also be structured to explicitly indicate the add, drop and through ports. Considering FIG. 6 and Eq. 20a above, Eq. 20b is proposed: [symbol]
P≡P_{ADD}+P_{DROP}+P_{THRU} [symbol] (20b)
where [symbol]
P_{ADD} [symbol] = [symbol] P_{DROP} [symbol] = [symbol] d [symbol] , and (20c) [symbol]
P_{THRU}=d [symbol] ( [symbol] h−1) (20d)
and as such, [symbol]
P_{ADD}+P_{DROP} [symbol] =2 [symbol] d. (20e)
As previously stated, every demand occupies both a termination-side port and line-side port on each of the two cross-connects at the opposite ends of the demand. Another common partitioning of ports is between termination-side ports and line-side ports. In this case Eq. 20b is rewritten according to Eq. 20f, which follows: [symbol]
P≡P_{CLIENT}+P_{LINE} [symbol] (20f)
where [symbol]
P_{CLIENT} [symbol] = [symbol] P_{ADD} [symbol] = [symbol] d [symbol] , and (20g) [symbol]
P_{LINE}=P_{DROP}+P_{THRU}=dh. (20h)

In the above analysis for the average number of ports, the extra transmission capacity and extra cross-connect ports that are required for network survivability were introduced. As discussed earlier, for single-link failure scenarios, the link or line-side capacity is increased by the fraction <κ>. Thus, the total number of cross-connect ports for shared line-side restoration of mesh networks is obtained by introducing the extra capacity factor into equations (20h) and (19c), which results in Eq. 21a, which follows: [symbol]
P⁷⁸ =d[1+(1+ [symbol] κ [symbol] ) [symbol] h]. (21a)
The same result is also obtained considering that the total number of ports is the sum of the number of channels carried on each of the links connected to the node and the number of channels terminating at the node. The former is given by the product of W^{o} and δ, and therefore yields Eq. 21b, which follows: [symbol]
P^{κ}=d+W^{o} [symbol] (1+ [symbol] κ [symbol] ) [symbol] δ [symbol] . (21b)
Using equations (13b) and (15b) and the definition of [symbol] κ [symbol] it can be determined and illustrated that Eq. 21b equates to Eq. 21a.

To appreciate how [symbol] P [symbol] scales with the number of nodes, equations (21) may be considered for uniform traffic in the limit when N is large compared to 1. In that limit and using equations (11c), (14c) and (17c) for [symbol] d [symbol] , [symbol] h [symbol] and [symbol] κ [symbol] , respectively, Eq. 21b may be rewritten according to Eq. 22a, which follows: [symbol]
P^{κ} [symbol] ≈[(1+2/ [symbol] δ [symbol] )/√ [symbol] δ [symbol] ]N^{3/2}. (22a)
For networks with [symbol] δ [symbol] in the range of 3≦ [symbol] δ [symbol] ≦4, the term in Eq. 21b dependent upon [symbol] δ [symbol] is within 14% of unity and for [symbol] δ [symbol] =3.5, the coefficient differs from 1 by less than 5%. Consequently, Eq. 22a may be rewritten according to Eq. 22b, which follows: [symbol]
P^{κ} [symbol] ≈N^{3/2}. (22b)
Thus, if the number of nodes in the network is approximately 24, then the average number of ports required is about 125. When N is about 100, then [symbol] P^{κ} [symbol] ˜3000. Similarly, the average traffic cross-section carried on the route between adjacent nodes is characterized according to Eq. 23, which follows: [symbol]
W^{κ}≈N^{3/2}/ [symbol] δ [symbol] (23)
when N is large compared to unity.

The average traffic handled by a cross-connect [symbol] χ [symbol] , measured in bits/second for example, is now computed straightforwardly from the average number of ports [symbol] P [symbol] and the communication bandwidth, either τ or B, associated with the basic unit of demand. Of course the former corresponds to the case when the channel utilization is 100% and the latter may correspond to a particular system increment or industry standard. Thus the average traffic handled by a cross-connect [symbol] χ [symbol] may be characterized according to Eq. 24a, which follows: [symbol]
χ(τ) [symbol] ≡ [symbol] P [symbol] τ, or (24a) [symbol]
χ(B) [symbol] >≡ [symbol] PB. (24b)
These direct proportionalities are independent of the demand model.

For the example network 200 of FIG. 2 having N=100 nodes and L=171 links, the mean number of ports on a cross-connect including ports for restoration is estimated to be [symbol] P^{κ} [symbol] ≅1061. The corresponding mean cross-connect traffic is 1072 Gb/s. For the smaller example network having N=25 nodes and L=42 links, the mean number of ports on a cross-connect including ports for restoration is estimated to be [symbol] P^{κ} [symbol] ≅141. The corresponding mean cross-connect traffic is 469 Gb/s.

To compute the variance of the number of ports, P, the number of ports required for the individual nodes must be determined. In the preceding sections, expressions for the number of channels on the individual links have been formulated; namely equations (15d-15g), Eq. 16b, and Eq. 17d. Consequently, it is necessary only to add the termination side channels to the sum of the channels on the δᵢ links connected to an individual node i to obtain the sum of the ports, P^{κ}ᵢ. Such an expression may be characterized according to Eq. 25a, which follows:

$${P}_{i}^{κ} = {d}_{i} + {\sum }_{j}^{{δ}_{i}} {W}_{ij}^{κ} \qquad ( 25 a )$$

Hence, the variance of P^{κ} may be computed using this expression and the definition of the variance, Eq. 13d In the spirit of clarifying the dependencies of the variance of P^{κ}, the following illustrates an example where the local extra capacity for restoration is specified by Eq. 17d. In this scenario the number of ports on a local cross-connect is characterized according to Eq. 26a, which follows:
P^{κ}ᵢ≅2dᵢ+[dᵢ/δ+W_{B/T}+W^{o} [symbol] / [symbol] δ [symbol] ]δᵢ+W^{o} [symbol] , (26a)
where for the total extra capacity associated with ports at node i, the approximation in Eq. 26b, which follows, was used:

$${κ}_{i} = {\sum }_{j}^{{δ}_{i}} {κ}_{ij} ≅ 1 + \frac{{δ}_{i}}{〈 δ 〉} \qquad ( 26 b )$$

Considering Eq. 26a, it is observed that there is a correlation between P^{κ}ᵢ and δᵢ that is moderated by the variations in W_{T}. The variance of P^{κ} for uniform demand is characterized according to Eq. 27a, which follows:
σ²(P^{κ})≅[ [symbol] d/δ+W_{B/T}+W^{o} [symbol] / [symbol] δ [symbol] ]²σ²(δ)+ [symbol] δ [symbol] ²σ²(W_{T}). (26c)
Instead, if Eq. 17g is used to specify the extra link capacity, then the total extra capacity associated with the ports at node i is given as:
κᵢ≅ [symbol] δ [symbol] [1/δᵢ+ [symbol] 1/δ [symbol] ] (27a)
and the total number of ports, P^{κ} is characterized according to Eq. 27b, which follows:
P^{κ}ᵢ≅2dᵢ+[dᵢ/δ+W_{B/T}]δᵢ+W^{o} [symbol] [symbol] δ [symbol] /δᵢ+W^{o} [symbol] [symbol] δ [symbol] [symbol] 1/δ [symbol] . (27b)
In this case, there is a contribution to the number of ports from the extra capacity (1/δᵢ) that is anti-correlated with the main term that is proportional to δᵢ. Thus, it is expected that the variance of P^{κ} in this scenario for the extra capacity, Eq. 17g, to be somewhat less than the variance obtained using the first form, Eq. 17d. To illustrate this behavior it was assumed that the variance of W_{T} is small and may be neglected. In this situation the standard deviation for the number ports for both scenarios (equations (17d) and (17g)) for the extra restoration capacity on a link for uniform demand may be characterized according to equations (28a) and (28b), respectively, which follow:
σ(P^{κ})= [symbol] W^{o} [symbol] (1+2/ [symbol] δ [symbol] )σ(δ), and (28a)
σ(P^{κ})= [symbol] W^{o} [symbol] σ(δ). (28b)
It is evident from the equations above that the standard deviation corresponding to the second form of the local extra capacity, which more strongly varies with the local degree of the node, is smaller by a factor of 1/(1+2/ [symbol] δ [symbol] ). This is understood considering that nodes with smaller degree require larger extra capacity on connecting links and nodes with larger degree require less extra capacity on connecting links. As a result of this anti-correlation the distribution of the required ports is narrowed.

For the example network 200 of FIG. 2 having N=100 nodes and L=171 links the mean and standard deviation of the degree of nodes is (δ)=3.4 and σ(δ)=1.1. Consequently, the standard deviation of the number of ports on a cross-connect based on the variance of the degrees of nodes is estimated to be σ(P^{κ})≅307 and σ(P^{κ})≅194 using Eq. 28a and Eq. 28b, respectively. Recall the mean number of ports including restoration capacity was estimated to be [symbol] P^{κ} [symbol] ≅1061. It is expected that the fractional deviations for the smaller example network having N=25 Nodes and L=42 links will be similar, as the statistics of the degrees of nodes are nearly the same by design. Again using Eq. 28a and Eq. 28b, the standard deviation of the number of ports on a cross-connect for this smaller network is estimated to be σ(P^{κ})≅38 and σ(P^{κ})≅24, respectively. Recall that the mean number of ports including restoration capacity was estimated to be (P^{κ})=141.

In summary, in this and the preceding section it has been shown that the Network Global Expectation Model may be used to understand and predict the mean and variability of the number channels carried on links and present at the nodes, including the effects resulting from network survivability. It will be appreciate by one skilled in the relevant art informed by the teachings of the present invention that although the model has been illustratively applied to the case of uniform, location-independent, or random demand in this section on the variance of the number of ports, the methodology is directly applicable to other demand profiles.

10. Percentage Add/Drop

Another important characteristic of the network is the percentage of add and drop traffic at a node. Referring to FIG. 6 and the one-way input ports on the cross-connect, it is observed that the average number of input ports occupied by traffic being either added or dropped at the node may be characterized according to Eq. 29a), which follows: [symbol]
P_{ADD}+P_{DROP}=D₁/N+D₁/N=2D₁/N. (29a)
The average number input ports occupied by traffic passing through the node may be characterized according to Eq. 29b), which follows: [symbol]
P_{THRU}=D₁( [symbol] h−1)/N. (29b)
By definition the average ratio of the number of local add/drop ports to local total ports may be characterized according to Eq. 30a), which follows:

$$〈 ρ 〉 ≡ \frac{1}{N} {\sum }_{n}^{N} {( {P}_{ADD} + {P}_{DROP} )}_{n} / {P}_{n} \qquad ( 30 a )$$

which may be computed by substituting expressions for both the numerator and the denominator. However, another practical and useful definition of the add/drop ratio average is the ratio of the network total number of add/drop ports to network total ports. In this second case the ration may be characterized according to Eq. 30b), which follows: [symbol]
ρ′ [symbol] =N( [symbol] P_{ADD}+P_{DROP} [symbol] )/N( [symbol] P_{ADD}+P_{DROP}+P_{THRU} [symbol] )=( [symbol] P_{ADD}+P_{DROP} [symbol] )/ [symbol] P (30b)
and therefore [symbol]
ρ′ [symbol] =2/[1+ [symbol] h]. (30c)
It should be noted that this relationship between [symbol] ρ′ [symbol] and [symbol] h [symbol] has been derived without reference to a model for the demands D₁. Consequently, it is a general result and not restricted to the case of uniform demands.

If the extra capacity for line-side restoration is accounted for, then the ratio average, [symbol] ρ′^{κ} [symbol] , of the number of add/drop ports to total ports (equations 21) may be characterized according to Eq. 30d, which follows: [symbol]
ρ′^{κ} [symbol] =2/[1+(1+ [symbol] κ [symbol] ) [symbol] h]. (30d)
The estimated add/drop ratios for the example network 200 of FIG. 2 having N=100 nodes and L=171 links without and with extra capacity for restoration are [symbol] ρ′ [symbol] ≅0.28 and [symbol] ρ′^{κ} [symbol] ≅0.19 using Eq. 30c and Eq. 30d, respectively. In comparison, the estimated add/drop ratios for the example network having N=25 nodes and L=42 links without and with extra capacity for restoration are [symbol] ρ′ [symbol] ≅0.49 through [symbol] ρ′ [symbol] ≅0.34 using Eq. 30c and Eq. 30d, respectively. This trend of increasing the fraction of through traffic as the number of nodes is increased is a general characteristic of a single-tier network with uniform demand. In the limit when N is large compared to 1 and the average degree of node is in the range 3≦ [symbol] δ [symbol] ≦4 the total number of ports is given by Eq. 22b and the add/drop ratio average may be characterized according to Eq. 30e, which follows: [symbol]
ρ′^{κ} [symbol] ≈2/√N. (30e)
Thus, for a mesh network of 25 nodes with shared line-side protection the ratio of add/drop to through channels is approximately 40% on average, and the percentage decreases as the number of nodes increases. Of course, this estimate is for the average node, and the percentage for a particular node can be larger or smaller depending upon the details of the network demand and topology. The use of shared termination-side protection will tend to increase the add/drop ratio.

On a separate note related to the add/drop ratio, it is also worth pointing out that Eq. 30c) may be inverted to express [symbol] h [symbol] as a function of [symbol] ρ′ [symbol] , according to Eq. 31, which follows: [symbol]
h=[2/ [symbol] ρ′ [symbol] −1]. (31)
Like Eq. 30c, Eq. 31 is a general result and not a function of the demand model.

The ratio of the add/drop traffic to total traffic for an individual note may be formulated using equations (25) and (29a). For example, considering the case when σ(W_{T}) is negligible, the result using Eq. 17d) for the extra capacity may be characterized according to Eq. 32a, which follows:

$${ρ}_{i}^{κ} = \frac{2 〈 d 〉}{{P}_{i}^{κ}} = \frac{2}{1 + ( 1 + \frac{2}{〈 δ 〉} ) \sqrt{\frac{〈 d 〉}{δ} \frac{{δ}_{1}}{δ}}} \qquad ( 32 a )$$

When N is large compared to 1 and [symbol] δ [symbol] is in the range of 3≦ [symbol] δ [symbol] ≦4, Eq. 32a may be approximated according to Eq. 32b, which follows:
ρ^{κ}₁≈(2/√N)[ [symbol] δ [symbol] ^{3/2}/(1+2/ [symbol] δ [symbol] )](1/δᵢ) (32b)
and so in this case
σ(ρ^{κ})/ [symbol] ρ^{κ} [symbol] ≈σ(1/δ)/ [symbol] 1/ι [symbol] . (32c)
Also,
ρ^{κ}_{min/max}/ [symbol] ρ^{κ} [symbol] ≈ [symbol] δ [symbol] /δ_{max/min}. (32d)
Thus, given that δᵢ may range from 2 to 8, it may be concluded that the add/drop ratio can conceivably range from ½ to 2 times the mean value.
C. Single Tier Networks—Network Cost
1. Node and Link Architecture

In the previous section, expectation values have been derived for the quantities of key network elements and network element subsystems required to carry out a basic cost analysis for a transport network. In this section the concept of the cost structure of network elements in relation to both the network elements and network element subsystems will be introduced. With an assumed cost structure, the total cost of the network as well as categories of costs may be computed, such as for transmission and bandwidth management. It is also illustrated by example how the network costs are compared using different combinations of technology, such as electronic and optical bandwidth management, using the Network Global Expectation Model.

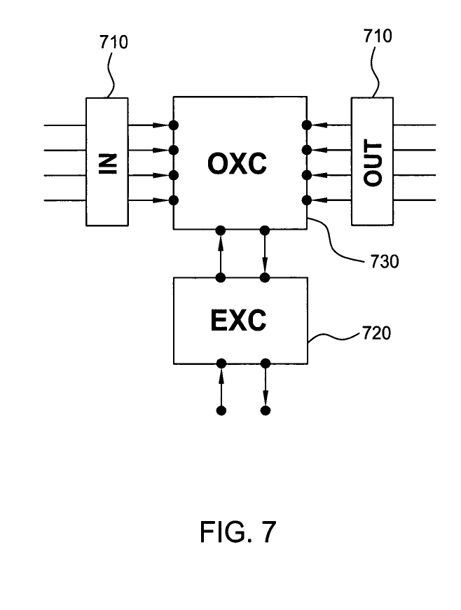

For the purpose of outlining the general principles of computing network costs using the Network Global Expectation Model, rudimentary cost structures are considered for the optical line system (OLS), electronic and cross-connect (EXC), and optical cross-connect (OXC). FIG. 7 depicts a high level block diagram of an exemplary architecture of OLS 710, EXC 720, and OXC 730 systems from a perspective near a node. For a cross connect using only electronic bandwidth management, a single electronic cross-connect can be used to replace the combination of EXC 720 and OXC 730. In FIG. 7, termination-side traffic enters the network at a node via the EXC 720 where it is groomed (i.e., switched and multiplexed, into the fundamental units of inter-terminal bandwidth destined for specific nodes of the network). The groomed output channels from the EXC 720 then enter the OXC 730, where they are directed to line systems placed along the inter-terminal links of the network according to the traffic routing scheme determined by either a centralized or distributed management system. In the architecture considered in FIG. 7, the interfaces between network elements are illustratively optical translators (OTs), which ensure that the cost comparisons are under conditions of fixed network capability (features) and network performance.

2. Transmission Cost Structure

A cost structure often used for optical fiber transmission is the average cost of transporting bandwidth (B) over distance (s). Herein this cost structure is represented as a cost coefficient, which is denoted as γ_{B-s}. The units of γ_{B-s} are dollars per gigabit per second per kilometer ($/Gbps/km). According to Gawrys, an approximate value for network transmission cost of a two-way channel may be characterized according to Eq. 33, which follows:
γ_{B-s}≈$30/Gbps/km (33)
based on historical data and projections.

Considering this cost structure, the individual and mean cost of a transmission link of a survivable mesh network may be characterized according to equations (34a) and (34b), respectively, which follow:
Cᵢ=γ_{B-s}βsᵢ, and (34a) [symbol]
cₗ [symbol] =γ_{B-s}βs≅γ_{B-s}βs, (34b)
where for the model of uniform demand under present consideration [symbol] β [symbol] is given by Eq. 16 with [symbol] κ [symbol] given by Eq. 17c and [symbol] s [symbol] is the expectation value of the link length. The expectation value of the link length, [symbol] s [symbol] , may be characterized according to Eq. 35a, which follows:

$$〈 s 〉 ≡ \frac{1}{L} {\sum }_{l}^{L} {s}_{l} \qquad ( 35 a )$$

where the set {s} are the physical lengths of the individual links. If the link lengths are known, then the expectation value [symbol] s [symbol] is quickly computed. Here, for the purposes of illustration, without introducing a specific set of link lengths, it is noted that for two-dimensional mesh networks the average link length scales inversely with the square-root of the number of nodes and is proportional to the square-root of the geographic area covered by the network. Thus, the expectation value of the link length, [symbol] s [symbol] , may be characterized according to Eq. 35b, which follows: [symbol]
s≅\sqrt{A}/(\sqrt{N}−1) (35b)
The total cost of transmission is characterized according to Eq. 36a, which follows:
C_{TRANS}=Lc₁ [symbol] , (36a)
wherein it should be clear that C_{TRANS} is an analytic function of only the independent input network variables (N, the number of nodes; L, the number of links; T, the total ingress/egress traffic; and A, the geographic area covered by the network), and so is easily computed. Consequently, when N is large compared to 1 and [symbol] δ [symbol] is in the range of 3≦ [symbol] δ [symbol] 4, C_{TRANS} may be approximated according to Eq. 36b, which follows:
C_{TRANS}≈≈_{B-s}T√A. (36b)

Currently, the yearly time averaged traffic carried by a combined voice and data backbone network in the continental United States is approximately 1 Tb/s. The daily and annual peak traffic load that the network must support is estimated to be about five times the average traffic. Thus, as an example, consider T=5 Tb/s. The geographic area of the continental U.S. is approximately A=8×10⁶ km². Thus, the approximate cost of transmission system equipment C_{TRANS} to support the present traffic is approximately $400M.

The approximate cost of transmission represented by Eq. 36b is obviously an over simplification as it contains no dependency on the number of links. That behavior is not because of a shortcoming of the global network expectation model, but rather is attributed to our assumption of the cost structure, equations (33) and (34). Clearly a more realistic model of the cost structure for the link should include an explicit dependency upon the cost of optical fiber cable, the cost of end terminals, the cost of OTs, the cost of amplifiers, and the cost of amplifier pumps, for example. Realizing this, a refined cost structure for a link is characterized according to Eq. 37a, which follows:
cᵢ=γₜ₀+γₜ₁τWᵢ+γₜ₂sᵢ+γₜ₃τWᵢsᵢ. (37a)
The expectation value for the cost of a link may then be characterized according to Eq. 37b), which follows:

$$〈 {c}_{1} 〉 = \frac{1}{L} {\sum }_{i}^{L} {c}_{i} = \frac{1}{L} {\sum }_{i}^{L} \{ {γ}_{t0} + {γ}_{t1} τ {W}_{i} + {γ}_{t2} {s}_{i} + {γ}_{t3} τ {W}_{i} {s}_{i} \} \qquad ( 37 b )$$

where the first term containing γₜ₀ reflects fixed costs for a link, such as the cost of the terminal equipment bays; the second term containing γₜ₁ includes costs that depend directly upon the number of channels carried, such as the number of OTs, the third term containing γₜ₂ includes costs that depend upon the distance traversed, such as the cost of trenching, cost of fiber, and the cost of amplifiers; and the fourth term containing γₜ₃ includes contributions that grow as the product of distance and wavelength, such as the cost of growth pumps and premium for specialized high capacity, long-distance fiber (e.g., dispersion-managed cable).

The total cost of transmission may then be characterized according to Eq. 37c, which follows:
C_{TRANS}=Lc₁=L{γₜ₀+γₜ₁τW+γₜ₂s+γₜ₃τWₛ [symbol] }. (37c)
Of the expectation values contained in equations (37), all have been previously computed except for [symbol] Wₛ [symbol] . As previously described, the number of channels on a link for the case of uniform demands is nearly independent of the particular link. Thus, [symbol] Wₛ [symbol] = [symbol] W [symbol] [symbol] s [symbol] and the total cost of transmission may be characterized according to Eq. 37d, which follows:
C_{TRANS}≅L{γₜ₀+γₜ₁τW+γₜ₂s+γₜ₃τWs}. (37d)
The above approximation is further validated when it is considered that under real world circumstances the coefficient γₜ₃ is small compared to the other coefficients and rarely are the optical line systems loaded to their maximum channel carrying capacity. In this case, to gain a better appreciation for how the total transmission cost depends upon the basic network variables, the last term is dropped. Upon substituting for the remaining expectation values in Eq. 37d, the cost of transmission may then be characterized according to Eq. 37e which follows:

$${C}_{TRANS} ( N , T ) ≅ \frac{1}{2} [ {γ}_{t0} + {γ}_{t2} 〈 δ 〉 N \sqrt{A} / \sqrt{N} - 1 + {γ}_{t1} [ \sqrt{A} ( 1 + 2 / 〈 δ 〉 / \sqrt{〈 δ 〉 - 1} ] ] T \qquad ( 37 e )$$

Here, the fixed startup costs (i.e., those independent of the traffic carried T) are evident in the first term, which is proportional to N or L (L=N<δ>/2, Eq. 13b).
3. Bandwidth Management Architectures and Cost Structure

a. Electronic Bandwidth Management Only

The Network Global Expectation Model provides the flexibility and ease of implementation to compute the network element variables and total network costs for a wide range of network sizes, total traffic, and a variety of architectural options. Herein it is illustrated how the costs for two different models of bandwidth management at the network nodes may be constructed. First considered is the case when an electronic cross-connect is used for both sub-rate grooming and cross-connect functions. In this case the total cost of bandwidth management is the cost of the electronic cross-connect, as is characterized in Eq. 38, which follows:
C_{BWM}=C_{EXC}. (38)
The total cost of the electronic cross-connects may be written in terms of the expectation value of the cost of the nodes according to Eq. 39a, which follows:
C_{EXC}=C_{EXC}N, (39a)
which follows directly from Eq. 8. An estimate of the current cost of high-speed electronic switching engines may be characterized according to Eq. 39b, which follows:
γₑₚ=$1K/Gbps, (39b)
which corresponds to a cost structure of the local EXC characterized according to Eq. 39c, which follows:
C_{EXC}=γₑₚχ(τ). (39c)
Making use of Eq. 24a, the corresponding expectation value may be characterized according to Eq. 39d, which follows: [symbol]
c_{EXC} [symbol] =γₑₚ [symbol] χ(τ) [symbol] =γₑₚτP. (39d)
Substituting for [symbol] c_{EXC} [symbol] in Eq. 39a and using equations (12a) and (21a), the value of C_{EXC} may be characterized according to Eq. 39e, which follows:
C_{EXC}=c_{EXC}N=2γₑₚT[(2+ [symbol] κ [symbol] ) [symbol] h]. (39e)
A more refined form for the cost structure of the electronic cross-connect, or IP router, that includes a startup term and a growth term may also be constructed according to Eq. 39f, which follows:
c_{EXC}=γₑ₀+γₑ₁χ_{τ.} (39f)
In this case
C_{EXC}(N,T)= [symbol] c_{EXC}N=γₑ₀N+2[(2+ [symbol] κ [symbol] ) [symbol] h]γₑ₁T. (39g)
These expressions for costs are valid independent of the demand model.

b. Electronic and Optical Bandwidth Management

Here a single-tier model using both optical and electronic bandwidth management is considered. More specifically, all traffic passes through the optical layer cross-connect and additionally all terminating traffic also passes through an electronic fabric for the purpose of channel grooming. Such an architecture is attractive when the cost of an optical port is significantly less than the cost of an electronic port for a given data rate. The total cost for BWM is thus characterized according to Eq. 40, which follows:
C_{BWM}=C_{EXC}+C_{OXC} (40)

i. Cost of Electronic Ports for Termination-Side Traffic

As before, it is assumed that the cost of the electronic switch consists of a startup term and a term proportional to the traffic handled. However, herein only the terminating traffic traverses the EXC. Thus the mean cost of an EXC is characterized according to equations (41a)-(41c), which follow: [symbol]
c_{EXC} [symbol] =γₑ₀+γₑ₁τP_{ADD}+P_{DROP} [symbol] =γₑ₀+γₑ₁2τP_{ADD} [symbol] , (41a)
which, using Eq. 12) for τ, may be rewritten as [symbol]
c_{EXC} [symbol] =γₑ₀+4γₑ₁T/N. (41b)
Consequently, [symbol]
C_{EXC} [symbol] =γₑ₀N+4γₑ₁T. (41c)

ii. Cost of Optical Ports for Thru and Add/Drop Traffic

The total cost of OXCs using the network global expectation formalism may be characterized according to Eq. 42a, which follows:
C_{OXC}=c_{oxc}N. (42a)
An estimate of the current cost of high-speed optical switching engines may be characterized according to Eq. 42b, which follows:
γₒₚ≈$2.5K/port. (42b)
Based on this cost structure and the architecture under consideration, which specifies that both through and termination-side traffic pass through the OXCs, the individual and mean OXC costs may be characterized according to equations (42c) and (42d), which follow:
c_{oxc}=γₒₚP, (42c)
and so [symbol]
c_{oxc} [symbol] =γₒₚP. (42d)
Substituting variables to obtain an expression that is independent of the demand model, the total cost of the OXCs may be characterized according to Eq. 42e, which follows:
C_{OXC}(N)= [symbol] c_{oxc}N=2γₒₚD(N)[(2+ [symbol] κ [symbol] ) [symbol] h], (42e)
where D(N) is the number of two-way demands.

As in the other examples, a cost structure for the optical cross-connect consisting of a startup term and a growth term may also be considered and may be characterized according to Eq. 42f, which follows:
c_{oxc}=γₒ₀+γₒ₁P (42f)
In this case the mean and total cost of the OXCs may be characterized according to equations (42g) and (42h), which follow: [symbol]
c_{oxc} [symbol] =γₒ₀+γₒ₁P (42g)
and
C_{OXC}(N)= [symbol] c_{oxc}N=γₒ₀N+2γ₀₁D(N)[(2+ [symbol] κ [symbol] ) [symbol] h]. (42h)
Summing the electronic and optical bandwidth management costs, results in Eq. 43), which follows:
C_{BWM}(N,T)=(γₑ₀+γₒ₀)N+4γₑ₁T+2γₒ₁D(N)[(2+ [symbol] κ [symbol] ) [symbol] h]. (43)

c. Comparison of Costs for Example Node Architectures

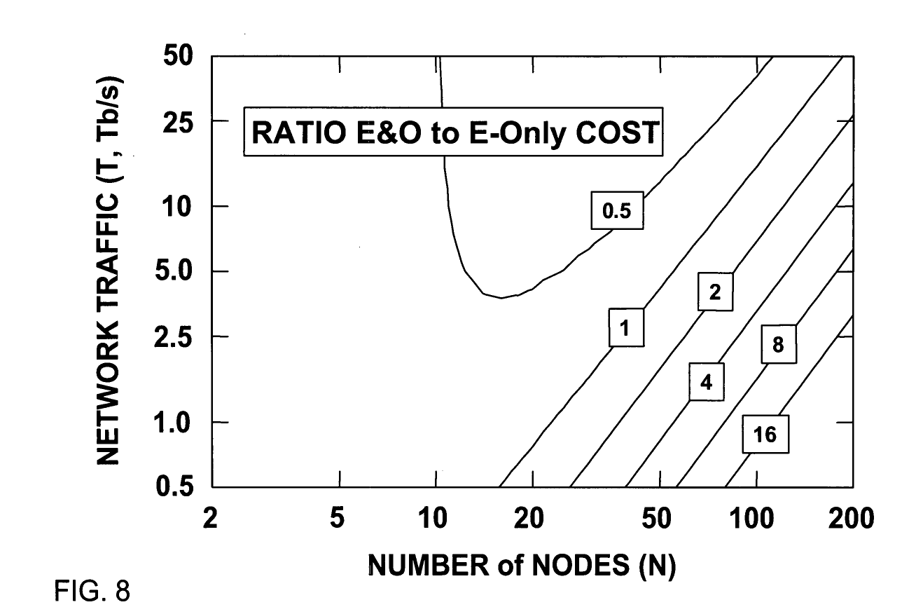

As an illustration of the application of the Network Global Expectation Model, the total costs for BWM for the two single-tier node architecture examples just described; namely electronic plus optical BWM and electronic-only BWM, are compared as a function of the number of nodes N and traffic T for fixed mean degree of node. The results of the calculations using the coarse cost structures for the EXC and OXC costs, equations (39b) and (42b), are graphed in FIG. 8.

FIG. 8 graphically depicts a plot of the total cost of bandwidth management using the combination of optical and electronic cross-connects compared to the total cost of bandwidth management using only an electronic cross-connect. The ratio is plotted as a function of the number of nodes, N, and two-way traffic, T. In the case of the optical and electronic architecture, it is assumed that all traffic follows through the optical switch fabric and additionally that all terminating traffic flows through the electronic switch fabric. The calculations performed and depicted in FIG. 8 are for uniform demand with restoration under the constraint [symbol] δ [symbol] =3.5. The cost structure (γ) used for the optical cross-connects and electronic cross-connects for this example are $2.5K/port and $1K/Gbps, respectively. It should be noted that these costs structures and values are rudimentary, intended to be illustrative, and should not be interpreted as definitive.

The Network Global Expectation Model of the present invention may be used to identify the region of the network parameter space where optical layer cross-connects may be introduced in conjunction with electronic cross-connects, or IP Routers, to economic advantage. The model accounts not only for the different characters of the cost structures as a function of traffic, but also accounts for the changing ratio of add/drop to through traffic as the number of nodes and links change. It is observed that for fixed values of the number of nodes for N greater than 15 that the total cost of bandwidth management using the electronic and optical (E&O) architecture decreases and becomes less than the cost of the electronic (E)-only solution as the total traffic increases. This is attributed to the assumption that the cost of an optical switch port is independent of channel bit-rate while the cost of an electronic switch port is directly proportional to the channel bit-rate. It is also observed that for fixed total network traffic that the cost of the E&O solution increases and becomes more expensive than the E-only solution as the number of nodes is increased and the mean degree of the nodes is held constant. This is because the mean termination-to-termination traffic decreases as the number of nodes is increased for fixed mean degree of the nodes (see FIG. 4), and consequently below some channel bit-rate, the fixed cost of an optical switch port becomes more expensive than an electronic switch port.

Of course, the details of the cost crossover depend upon the particulars of the technology price points (cost structure and coefficients), and consequently, the graph of FIG. 8 is intended only to demonstrate the capabilities and possibilities of the global expectation model and not to make a definitive recommendation. It should be noted that herein it has been implicitly assumed via the cost structures that the respective cross-connects technologies are capable of providing the required switch and backplane capacities. In the absence of more refined cost structures that account for these limitations, other equations and graphs of the model may be used, such the total number of required ports (Eq. 21b)) or the mean cross-connect traffic, to identify regions of the network traffic-node space that are beyond the capabilities of a particular architecture or technology.

4. Total Network Costs

The total network cost may be computed by summing the cost for transmission and bandwidth management using the formulae derived herein. For completeness equation 4 may be characterized according to Eq. 44, which follows:
C_{T}=C_{TRANS}+C_{BWM} (44)

Clearly, a useful attribute of the model is that the relative cost of transmission and bandwidth management can easily and quickly be determined.

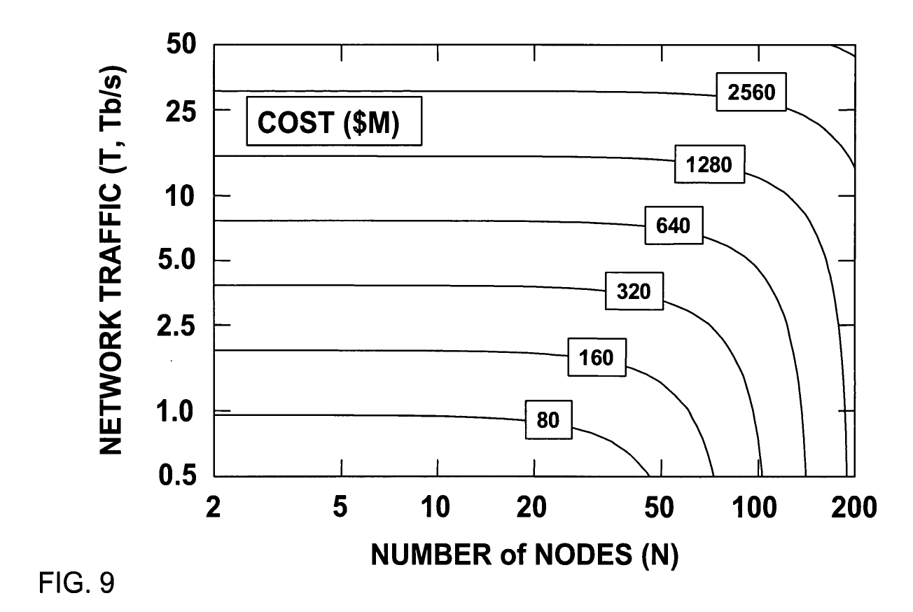

To illustrate the utility of the Network Global Expectation Model, FIG. 9 depicts a calculation of the total cost of a mesh network with uniform demand as a function of the number of nodes N and total traffic T. FIG. 9 graphically depicts a plot of the total cost of a mesh network with uniform demand as a function of the number of nodes N and total traffic T. The sum of transmission and bandwidth management equipment costs, C_{T}(N,T), is graphed as a function of the number of nodes, N, and total two-way traffic, T using a contour plot. As in FIG. 8, the calculations in FIG. 9 are for uniform demand with restoration under the constraint [symbol] δ [symbol] =3.5. The cost structures used for the optical line systems, electronic cross-connects, and optical cross-connects are $30/Gbps/km, $1K/Gbps, and $2.5K/port, respectively. Again, it should be noted that these cost structures and values are intended only to illustrate the capabilities and possibilities of the global expectation model of the present invention and should not be interpreted as definitive.

The results of FIG. 9 are for the case where the nodal bandwidth manager consists of a combination of optical layer and electronic cross-connects and the geographic area corresponds to the continental U.S. In the accounting, equations (33) and (34), equations (39b) and (39c), and equations (42b) and (42c) were used for the cost structure of the transmission links, electronic cross-connects, and optical cross-connects, respectively.

Among the features that may be observed by considering FIG. 9 is the impact of the cost of bandwidth management as the number of nodes increases. A qualitatively similar result is obtained for the case of electronic-only bandwidth management. Considering Eq. 22b for total number of cross-connect ports and Eq. 30e for the add/drop ratio, the large cost for large N may be interpreted to be a consequence of the single layer architecture. In effect, single-tier (flat) networks can not practically scale to very large number of nodes because as the number of nodes increases an increasing fraction of the traffic processed at each node is through traffic destined for other nodes. It is for this reason that the voice and packet networks are organized hierarchically based on geographic communities.

The underlying phenomenon may also be the driving factor behind more broadly observed scaling behavior of networks and biological systems. Clearly there are performance and operational tradeoffs between single-tier and multi-tier networks, and network operators will adjust the number of nodes and architecture in the backbone depending upon the costs for transmission and bandwidth management; changing cross-connect, line-system, and technology price points; and the evolution of traffic demand.

D. Network Global Expectation Model for Multi-Tier Network

1. Core and Satellite Nodes

The formulation of the two-tier network global expectation model is presented below using the general methodology of the Network Global Expectation Model described in detail above as a foundation. While the two tier model is presented for purposes of explication, it will be understood by persons skilled in the art that the principles of the present invention are extensible to networks having a hierarchical structure of more than two tiers.

The communication network is defined as the combination of a network graph, denoted G, consisting of a set of N nodes {nᵢ} a set of L connecting two-way links, or edges, {lᵢ}, and a network traffic. The pair-wise, two-way communication traffic between terminals located at different nodes is represented by the symmetric demand matrix [d] with elements dᵢⱼ and the total ingress/egress traffic T. The total number of two-way network demands is denoted D. The degrees of the nodes are the numbers of links connected to each of the nodes and form a set {δᵢ}.

Next the entire network of N nodes and L links, which has heretofore been considered as a single-tier network of peer nodes, is divided into two distinct categories consisting of a set of N_{C} core (major) nodes {n_{C}} and a set of N_{S} satellite (minor) nodes {n_{S}} Each node has a corresponding population of end users. The distinct populations of the sets of core and satellite nodes are denoted by the sets {p_{C}} and {p_{S}}, respectively. These core and satellite nodes will become the foundation of the backbone and regional networks. If N and N_{C} are considered as independent variables, then N_{S} is a dependent variable and is given by
N_{S}≡N−N_{C}. (45)

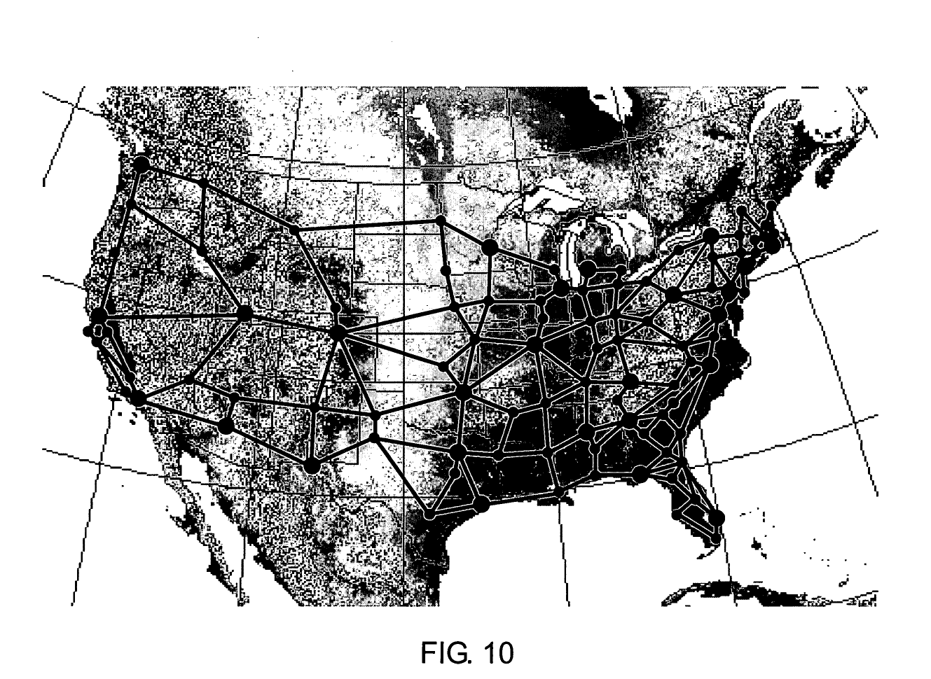

To assist in visualizing the concepts discussed here, FIG. 2 illustrates a long-distance fiber-optic network of N=100 nodes and L=177 links. This view may be interpreted as a single-tier architecture of the network. FIG. 10 illustrates the same network of FIG. 2 where the nodes have been organized (divided) into a two-tier architecture with N_{C}=25 core nodes and N_{S}=75 satellite nodes. The core nodes are represented by the larger filled dots, whereas the satellite nodes are represented by the smaller filled dots. Each tier of the two-tier networks has an associated set of links, which may overlap spatially, i.e. share a common location, for example a right-of-way or conduit. In the particular example shown in FIG. 10, there are L_{R}=177 regional links connecting the satellite and core nodes, which is identical to the number of links in the single-tier architecture of FIG. 2. Additionally there are L_{B}=44 backbone links directly interconnecting the core nodes, which overlay the regional links. Further details of the network and tiers are described below in the following sections.

2. Regions and Backbone

Next the network of core and satellite nodes is organized into a collection of regions—each region including a core node, which will serve as a backbone node, and a set of satellite nodes. In effect, each core node serves as a hub for the regional network it defines and also as a node of the backbone network. Each satellite node has a connection to one or more core nodes, and consequently each satellite node is a member of one or more regional networks. {N_{SR}} is defined as the set of the numbers of satellite nodes in each of the network regions. Because the satellite nodes are members of one or more regions, the sum of the satellite nodes for all regions, ΣN_{SR}, exceeds N_{S} and is given exactly by
ΣN_{SR}= [symbol] δ_{R}N_{S}≧N_{S}, (46)
where [symbol] δ_{R} [symbol] is the mean degree of the regional satellite nodes and will be discussed further below. On average a service region R contains [symbol]
N_{SR} [symbol] = [symbol] δ_{R}N_{S}/N_{C} (47)
satellite nodes. Consequently, the mean number of nodes (core and satellites) [symbol] N_{X} [symbol] networked within a single regional community may be written as [symbol]
N_{X}=N_{SR} [symbol] +1. (48)
3. Accounting of Demands

a. Population-Dependent Demands

In general, the traffic between pairs of node terminations is not constant across all node pairs, nor is the total traffic terminating at nodes identical for all nodes. Here, to permit the evaluation of the effects of a class of non-uniform traffic on network and network element requirements, the Network Global Expectation Model is extended explicitly to include population-dependent traffic. The cases of uniform and random demand are treated in the sections above dealing with population-independent demand for the single tier network model.

Population-dependent traffic is a type of non-uniform demand wherein the number of terminal-to-terminal demands between node i and node j, dᵢⱼ, is proportional to the product of the corresponding end-user populations, i.e.
dᵢⱼ=pₒ²pᵢpⱼ, i≠j (49)
where pᵢ and pⱼ represent the populations of nodes i and j, and pₒ² is a constant of proportionality. For completeness, the fundamental basis of the population-dependent demand is summarized in the Appendix. Without loss of generality, the constant pₒ may be absorbed into the definition of p.

b. Satellite and Core Demands

With the above representation of the population-dependent demands, Eq. 49, it is possible to total the number of demands terminating at a given node. Considering the two-tier description of the nodes introduced above and summing Eq. 49 over the nodes j, the number of demands originating at satellite node Sᵢ is

$${d}_{Si} = {\sum }_{j \neq i}^{{N}_{s} - 1} {p}_{Si} {p}_{Sj} + {\sum }_{j}^{{N}_{c}} {p}_{Si} {p}_{Cj} , \qquad ( 50 )$$

and the sum of all two-way demands terminating at all satellite nodes, D_{S}, is

$${D}_{s} = \frac{1}{2} [ {\sum }_{i}^{{N}_{s}} {\sum }_{j \neq i}^{{N}_{s} - 1} {p}_{Si} {p}_{Sj} + {\sum }_{i}^{{N}_{s}} {\sum }_{j}^{{N}_{c}} {p}_{Si} {p}_{Cj} ] . \qquad ( 51 a )$$

The summations in Eq. 51a may be computed straightforwardly if the details of the node populations are known; however, it is also useful to relate the number of demands to expectation values of the network characteristics.

To focus on the treatment of the population-dependent, non-uniform demand, two notations are used to simplify the representation of the summations encountered, such as in Eq. 51a. The first simplifying notation is the use of the bracket symbol, [symbol] q [symbol] to represent the expectation, or mean (average), value of a set of values {q}, as indicated in Eq. A.1 of the Appendix. The second simplifying notation is to represent the exclusion of the self-communication demands (j=i), such as in Eq. 49, in a way that the summations may be extended over all terms (j). As the total number of terms in the summation with j≠i is m−1, to a good approximation

$${\sum }_{i}^{m} {\sum }_{j \neq i}^{m - 1} {p}_{i} {q}_{j} ≅ ( 1 - \frac{1}{m} ) {\sum }_{i}^{m} {\sum }_{j}^{m} {p}_{i} {q}_{j} . \qquad ( 51 b )$$

Therefore, symbolically one can write

$${\sum }_{i}^{m} {\sum }_{j \neq i}^{m - 1} {p}_{i} {q}_{j} = {m}^{2} ( 1 - \frac{1}{m} ) 〈 p 〉 〈 q 〉 = m ( m - 1 ) 〈 p 〉 〈 q 〉 , \qquad ( 51 c )$$

where the approximate treatment of the self-communication terms is implicit in the appearance of the factor m(m−1). By using this notation, the reader may then later chose to more accurately estimate the self-communication term or to drop the term in m relative to m² to consider the effect of loop-back, self-communication demands on the network requirements.

Using the notations introduced above, the sum of all two-way demands terminating at all satellite nodes, D_{S}, Eq. 51a, is
D_{S}≅½[N_{S}(N_{S}−1) [symbol] p_{S}p_{S}+N_{S}N_{C}p_{S}p_{C} [symbol] ]. (51d)
The mean value of D_{S} is [symbol]
D_{S}=D_{S}/N_{S}, (51e)
and the corresponding mean number of demands originating at a satellite node is [symbol]
d_{S} [symbol] =2D_{S}/N_{S}. (52)
Next the number of demands terminating at all of the core nodes is determined. The number of demands originating at core node Cᵢ is

$${d}_{Ci} = {\sum }_{j}^{{N}_{s}} {p}_{Ci} {p}_{Sj} + {\sum }_{j \neq 1}^{{N}_{c} - 1} {p}_{Ci} {p}_{Cj} , \qquad ( 53 )$$

and the sum of all demands terminating at all core nodes is

$${D}_{C} = \frac{1}{2} [ {\sum }_{i}^{{N}_{c}} {\sum }_{j}^{{N}_{s}} {p}_{Ci} {p}_{Sj} + {\sum }_{i}^{{N}_{c}} {\sum }_{j \neq 1}^{{N}_{c} - 1} {p}_{Ci} {p}_{Cj} ] , \qquad ( 54 a )$$

which in analogy to D_{S} in Eq. 51a-e becomes
D_{C}≅½[N_{C}N_{S}p_{C}p_{S}+N_{C}(N_{C}−1)p_{C}p_{C} [symbol] ]. (54b)
As in Eq. 51d, the approximate sign in Eq. 54b arises only because of the approximate treatment of the accounting (subtraction) of the self-communication terms, and is otherwise exact.

The corresponding mean number of demands originating at a core node is [symbol]
d_{C} [symbol] =2D_{C}/N_{C}, (55)
where D_{C} is given by Eq. 54b.

The total number of two-way demands for the entire network is
D=D_{S}+D_{C}. (56a)
Using Eqs. 51d and 54b, D may be approximated by
D=½└N_{S}(N_{S}−1) [symbol] p_{S} [symbol] ²+2N_{S}N_{C}p_{C}p_{S}+N_{C}(N_{C}−1) [symbol] p_{C} [symbol] ²┘. (56b)

c. Regional and Backbone Demands

In this section, the demands are tallied among the satellite and core nodes of the network that may be serviced within the regional networks, i.e. without requiring access to the backbone network. Having identified the regional traffic, the traffic that is carried on the backbone network may be deduced by subtracting the regional subtotal from the total network demand. From there, it is possible to determine the network element needs of the regional and backbone networks, which will in turn permit us to evaluate the respective costs. It will be shown that the regional and backbone traffic can be directly and fundamentally related to expectation values of the basic network variables for the case of non-uniform demand.

Let [symbol] D_{X} [symbol] denote the mean number of demands among the [symbol] N_{X} [symbol] nodes networked within a region. As indicated in Eq. 48, the [symbol] N_{X} [symbol] nodes consist of [symbol] N_{SR} [symbol] satellite nodes and one core node. The number of one-way demands originating at the ith satellite node and ending at the jth satellite within the kth region is,

$${d}_{SRi}^{k} = {\sum }_{j \neq 1}^{{N}_{SR}^{k}} {p}_{Si} {p}_{Sj} , \qquad ( 57 a )$$

If the mean degree of the satellite nodes within the regional networks, [symbol] δ_{R} [symbol] is greater than 1, then according to our convention a satellite node belongs to more than one regional network and the above sum over-counts demands by the factor [symbol] δ [symbol] . Consequently, the number of unique two-way demands among the satellite nodes within the kth region using Eq. 57a is,

$${D}_{SR}^{k} = \frac{1}{2 〈 {δ}_{R} 〉} {\sum }_{i}^{{N}_{SR}^{k}} {\sum }_{j \neq 1}^{{N}_{SR}^{k} - 1} {p}_{Si} {p}_{Sj} . \qquad ( 57 b )$$

Using the same methodology as in Eqs. 51a-e, D^{k}_{SR} of Eq. 57b may be rewritten as

$${D}_{SR}^{k} = \frac{1}{2 〈 {δ}_{R} 〉} {N}_{SR}^{k} ( {N}_{SR}^{k} - 1 ) 〈 {p}_{S}^{k} 〉 〈 {p}_{S}^{k} 〉 . \qquad ( 57 c )$$

Now, Eq. 57c shows that the product N^{k}_{SR} [symbol] p_{S}^{k} [symbol] is the population of the kth satellite region, P^{k}_{SR}, and that N^{k}_{SR} is a constant for all i,j for a given k. Thus, Eq. 57c may be written as

$${D}_{SR}^{k} = \frac{1}{2 〈 {δ}_{R} 〉} ( 1 - \frac{1}{{N}_{SR}^{k}} ) {P}_{SR}^{{k}^{2}} . \qquad ( 57 d )$$

Next the mean value of the number of satellite demands networked in a region is determined by averaging Eq. 57d over all N_{C} regions. It can be assumed that 1/N^{k}_{SR} is small compared to 1 and approximate this factor by 1/ [symbol] N_{SR}^{k} [symbol] . Then,

$$〈 {D}_{SR}^{k} 〉 ≅ \frac{1}{2 〈 {δ}_{R} 〉} ( 1 - \frac{1}{〈 {N}_{SR}^{k} 〉} ) 〈 {P}_{SR}^{{k}^{2}} 〉 , \qquad ( 57 e )$$

and using the definition of the mean value of a variable and the general property of the variance of a variable (See Appendix), the equation may be rewritten as,

$$〈 {D}_{SR}^{k} 〉 ≅ \frac{1}{2 〈 {δ}_{R} 〉} ( 1 - \frac{1}{〈 {N}_{SR}^{k} 〉} ) \{ {〈 {P}_{SR}^{k} 〉}^{2} + {σ}^{2} ( {P}_{SR}^{k} ) \} , \qquad ( 57 f )$$

where the superscripts k have been retained within the expectation values to denote that the averages are over the N_{C} regions of the network. Using [symbol] P^{k}_{SR} [symbol] = [symbol] N^{k}_{SR} [symbol] [symbol] p^{k}_{S} [symbol] , Eq. 57f may be rewritten to express the lead term of the sum as a function of [symbol] N_{SR} [symbol] and [symbol] p_{S} [symbol] , viz. [symbol]
D_{SR} [symbol] ≅½(1−1 [symbol] N_{SR} [symbol] ){ [symbol] N_{SR} [symbol] ²p_{S} [symbol] ²+σ²(P_{SR})}/ [symbol] δ_{R} [symbol] . (57g)

It should be noted from the form of Eq. 57g that embodied in this result is the essence of the consideration of non-uniform demand. Namely, in addition to the number of demands estimated by the square of the mean of the populations, the number of demands is increased by a term proportional to the variance of the populations. Thus, through the use of expectation values computed exactly or approximately with high accuracy over the entire network, the 2m variables and m² pairs of the general sets {p} and {q} will be reduced to only a small number of statistical variables from among [symbol] p [symbol] , [symbol] q [symbol] , σ²(p), σ²(q), and σ²(p,q). This significant decrease in complexity and the corresponding analytic formulae provide a compact and easily applied method to determine the needs and costs of large networks, including non-uniform demand, accurately and very quickly using only very modest computational resources. Note, when the mean degree of the regional nodes is greater than 1, there is the opportunity to select which of multiple regional networks will support a given regional demand. This provides the opportunity to balance the regional traffic among the core nodes, and so reduces the contribution from the variance of the populations. In the limit where the variance is small compared to the mean, the result for D_{SR} reduces to the case of uniform demand, i.e. [symbol]
D_{SR} [symbol] ≅½(1−1 [symbol] N_{SR} [symbol] ) [symbol] N_{SR} [symbol] ²p_{S} [symbol] ²/ [symbol] δ_{R} [symbol] . (57h)

Next the mean number of demands is evaluated between the core node and satellite nodes that are networked in a region, which when combined with Eq. 57h will yield the mean of the total demand networked in a region, [symbol] D_{X} [symbol] . This analysis is started in a manner analogous to Eq. 57a by considering the one-way demands originating at the ith satellite node in the kth region and ending at the core node served by that region. In the population-dependent demand model the number of these demands is
d^{k}_{sCi}=2p^{k}_{Si}p^{k}_{C}, (58a)
The sum total of two-way demands among the core node and all of the satellite nodes served in the region is, building on Eq. 58a,

$${D}_{SC}^{k} = {\sum }_{i}^{{N}_{SR}^{k}} {p}_{Si}^{k} {p}_{C}^{k} , \qquad ( 58 b )$$

which may be written as
D^{k}_{SC}=N^{k}_{SR}p^{k}_{S}p^{k}_{C}. (58c)
or, again recognizing N^{k}_{SR} [symbol] p^{k}_{S} [symbol] =P^{k}_{SR},
D^{k}_{SC}=P^{k}_{SR}p^{k}_{C}. (58d)
The mean number of core-satellite demands evaluated over all regions is [symbol]
D^{k}_{SC}≅P^{k}_{SR}p^{k}_{C} [symbol] . (58e)
Using the definition of the covariance, Eq. 58e may be recast as [symbol]
D^{k}_{SC}=P^{k}_{SR}p^{k}_{C} [symbol] +σ²(P^{k}_{SR}, p^{k}_{C}). (58f)
or [symbol]
D_{SC}=N_{SR}p_{S}p_{C} [symbol] +σ²(P_{SR}, p_{C}). (58g)
Here again, embodied in this companion result, Eq. 58g, is the essence of the consideration of non-uniform demand. It can be seen that in addition to the number of demands estimated by the product of the means of the populations, the number of demands is increased by the covariance of the populations. If the population of the core node is not correlated to the total population of the satellite nodes in the region, then the covariance is zero and Eq. 58h reduces to that of the case of uniform demand, namely [symbol]
D_{SC}=N_{SR}p_{S}p_{C} [symbol] . (58h)

Having established the above intermediate results, it is possible to complete the evaluation of the total number of demands networked within the regions, D_{R}, and the total number of demands networked within the backbone, D_{B}. The mean number of demands networked in a region, [symbol] D_{X} [symbol] , is just the sum [symbol]
D_{X}=D_{SR}+D_{SC} [symbol] , (59a)
with the terms on the right specified by Eq. 57g and Eq. 58g. The corresponding mean number of regional demands that terminate at a node is [symbol]
d_{X} [symbol] =2 [symbol] D_{X}/N_{X} [symbol] . (59b)
The total number of demands networked within all the regions of the core nodes is therefore
D_{R}=N_{C}D_{X} [symbol] . (60)
Consequently, the number of demands carried within the backbone among the core nodes, which includes core-core, inter-region-satellite, and inter-region-satellite-satellite demands, is
D_{B}=D−D_{R} (61)
where the total number of network demands, D, was previously evaluated in Eq. 56. The mean number of demands carried across the backbone that are terminated by a backbone node, [symbol] d_{B} [symbol] , is given simply by [symbol]
d_{B} [symbol] =2 [symbol] D_{B}/N_{C} [symbol] (62)
and the mean number of demands carried across the backbone network between a pair of backbone nodes, [symbol] D_{BB} [symbol] , is given by [symbol]
D_{BB}=D_{B}/[N_{C}(N_{C}−1)/2]. (63)
It is worth noting at this point that Eqs. 60 and 61 for D_{R} and D_{B} along with the set of preceding expressions describe how the partitioning of the network traffic between the regional and core nodes depends upon the variables of the two-tier network architecture. One may verify using the equations derived above that, for population-dependent, location-independent demand, the fractions of the traffic carried in the regional and backbone networks are given approximately by,
D_{R}/D≅δ_{R}/N_{C} (64a)
and
D_{B}/D≅1− [symbol] δ_{R}/N_{C}. (64b)

An interesting aspect of such a two-tier network is that the portions of the demands carried in the regional and backbone networks are determined by the absolute number of core nodes, and not the ratio of the number of core nodes to the total number of nodes. As an illustration of the model, Eq. 64b shows that if the degrees of the nodes of the regional networks δ_{R} are in the range of 2 to 3 and the number of core nodes N_{C} is in the range of 20 to 30, then about 90% of the traffic of the network is carried across the backbone. This fraction increases as the number of core nodes increases. Thus, the use of a backbone network can serve to concentrate the network traffic onto fewer longer distance links. This can be advantageous if the cost structure of the transmission system is such that the unit cost of transport falls as the system load and reach are increased, such as is the case for ultra-long-haul transmission systems, for example.

4. Traffic and Demand Bit-Rates

The basic traffic demand bit-rate, τ, is defined by the ratio of the total two-way network traffic, T, to the total number of two-way demands, D, i.e.
τ≡T/D. (65)
As the number of demands in the regions and backbones has been counted, the corresponding values of network traffic may also be computed. Using the total number of demands carried in the backbone and the demand channel bit-rate, τ, the total traffic carried within the backbone can be computed as,
T_{B}≡τD_{B}=TD_{B}/D, (66)
and the mean backbone traffic demand bit-rate, [symbol] τ_{B} [symbol] , can be computed as, [symbol]
τ_{B}=τD_{BB}=TD_{BB}/D. (67)
The total traffic networked within the regions is
T_{R}≡τD_{R}=TD_{R}/D, (68a)
or using Eq. 61,
T_{R}=T−T_{B}. (68b)
The mean regional traffic between a satellite node and a core node is [symbol]
τ_{S}=τD_{S}=TD_{S}/D, (69)
where [symbol] D_{S} [symbol] is given by Eq. 7e.

5. Degrees of Nodes, Numbers of Links, and Link Lengths

Viewing the totality of N nodes and L links as a single-tier network, each of the nodes has an associated degree of node, which is specified by the number of links (or routes) the node is connected to. As in the general formulation of the model, the mean degree of the entire network may be computed from the individual degrees of nodes and is given by,

$$〈 δ 〉 = ( 1 / N ) {\sum }_{i}^{N} {δ}_{i} = 2 L / N . \qquad ( 70 a )$$

Next the degrees of the sets of core and satellite nodes are considered, again as specified by the set of L links. The summation of Eq. 70a may be reorganized into two terms corresponding to the sets of core and satellite nodes with the result [symbol]
δ [symbol] =(N_{C}/N) [symbol] δ_{C} [symbol] +(N_{S}/N) [symbol] δ_{S} [symbol] , (70b)
where [symbol] δ_{C} [symbol] is the mean degree of the core nodes and [symbol] δ_{S} [symbol] is the mean degree of the satellite nodes. Typically the mean degree of the satellite nodes is less than the mean degree of the core nodes, and if so [symbol]
δ_{S} [symbol] ≦ [symbol] δ [symbol] ≦ [symbol] δ_{C} [symbol] . (70c)

If one were to consider the mean degree of the core nodes and the mean degree of the satellite nodes as independent variables, then together with the number of core nodes and the number of satellite nodes, the value of [symbol] δ [symbol] is specified by Eq. 70b. However, for the purpose of analyzing the tradeoffs in network design, as in our earlier work, here the number of nodes N and mean degree [symbol] δ [symbol] are considered to be independent variables. In this case the number of links L is specified by Eq. 70a. If in addition to N and [symbol] δ [symbol] , N_{C} is considered to be an independent variable, then N_{S} is uniquely determined by Eq. 1. Further in this scenario of the choice of independent variables, if the mean degree of the core nodes [symbol] δ_{C} [symbol] is considered to be an independent variable, then the mean degree of the satellite nodes [symbol] δ_{S} [symbol] is uniquely specified by Eq. 70b. In summary, for specificity in the analyses that follow, one can consider N, [symbol] δ [symbol] , N_{C}, and [symbol] δ_{C} [symbol] as independent variables and the relationships of Eqs. 1, 70a, and 70b can be used to determine the values of the dependent variables L, N_{S}, and [symbol] δ_{S} [symbol] .

Next attention is turned to the architectures of the regional and backbone tiers of the network, which are constructed using the satellite and core nodes and the links of the network. There are myriad possibilities. For specificity the two-tier network is considered as an overlay of two parallel networks in which the collection of regional networks has the same topology of nodes and links as the single-tier network and the backbone network is superimposed on top of the collection of regional networks. In this scenario all of the L links of the network are available to route the intra-regional traffic, and the backbone network consisting of fewer nodes and links is used to service the inter-regional traffic. Noting that the core node sites are also considered sites of the regional networks, in this scenario the total number of regional links across the entire network is given by
L_{R}=L. (71a)
A direct consequence of the assumptions embodied in Eq. 71a is that the mean degree of the regional networks corresponds to the mean of the entire network, i.e. [symbol]
δ_{R} [symbol] = [symbol] δ [symbol] . (71b)

Note, while the regional and backbone networks may share the same links such as conduits, in general, they do not share the same system resources such as line systems. In alternative scenarios for the regional network architectures one might consider that the total number of distinct links of the regional networks in less than L. For example, it might be considered that all of the satellite nodes are effectively converted to degree-2 (degree=2) nodes. In such a scenario the mean degree of the regional networks is in analogy to Eq. 70b [symbol]
δ_{R}=(N_{C}/N) [symbol] δ_{C} [symbol] +2(N_{S}/N). (71c)
In this alternative scenario, the number of links in the regional network is
L_{R}= [symbol] δ_{R}N/2. (71d)

Next the backbone network and use the core nodes are considered together with a set of links {l_{B}}, L_{B} in number, to define this portion of the network. If the set of core links is explicitly provided, then it is possible to evaluate the capacity requirements placed on the links. As a specific architecture for the backbone, the following description will consider the entire network graph with the satellite nodes removed, and the dangling links connected nominally (on average) in pairs to form a backbone network with the fewest number of hops between core nodes. By construction, the mean degree of such a backbone network then satisfies [symbol]
δ_{B} [symbol] ≡ [symbol] δ_{C} [symbol] . (72a)
In this case the mean degree of the backbone nodes is deliberately nominally unchanged from the core nodes of the original single-tier network and represents close to an upper bound for the mean degree of the backbone network.

As another scenario, the mean degree of the nodes of the backbone network may be approximated by the mean degree of the original single-tier network, i.e. [symbol]
δ_{B} [symbol] = [symbol] δ [symbol] . (72b)
The number of links constituting the backbone network, L_{B}, may be deduced from [symbol] δ_{B} [symbol] via the relation [symbol]
δ_{B} [symbol] ≡2L_{B}/N_{C}, (72c)
where N_{C} is the number of core nodes. Thus, having originally specified [symbol] δ [symbol] and [symbol] δ_{C} [symbol] as independent network variables and now choosing [symbol] δ_{R} [symbol] and [symbol] δ_{B} [symbol] , or equivalently L_{R} and L_{B}, the global properties of the two-tier network graph have been characterized. If other effective architectures are to be considered, that may be accomplished by choosing alternative values for [symbol] δ_{R} [symbol] and [symbol] δ_{B} [symbol] .

To close this section, the mean values of the physical lengths of the links of the regional and core networks are determined. Taking into consideration the overlay interpretation introduced above, the mean length of a link of the regional networks [symbol] s_{R} [symbol] is identical to the mean length of a link of the single-tier network. If the details of the geography of the network links are provided, then the mean values of the link lengths are calculated directly from the set of link lengths. However even in the absence of specific details, the mean link lengths based on the topology and dimensionality of the network may be estimated using approximate analytic expressions. As the networks under consideration are nominally planar, this approximation of [symbol] s_{R} [symbol] made be written as, [symbol]
s_{R}≅\sqrt{A}/(\sqrt{N_{C}}−1), (73a)
where A is the geographic area served by the entire network of N nodes. In general within the overlay interpretation, the geographic area within the boundary of the core nodes may be less than or equal to the area of the entire network. Here for specificity the latter case is considered, and so the mean distance of the links of the backbone network [symbol] s_{B} [symbol] is approximated as, [symbol]
s_{B}≅\sqrt{A}/(\sqrt{N_{C}}−1). (73b)

6. Demands and Traffic on Links

a. Core

The mean number of network demands, [symbol] W_{B} [symbol] , and traffic, [symbol] β_{B} [symbol] , carried on a backbone link may be computed for location-independent demand using the results of the general formulation of the Network Global Expectation Model so that, [symbol]
W_{B}=d_{B}h_{B} [symbol] / [symbol] δ_{B} [symbol] . (74a)
For network survivability additional capacity is required on the backbone links, and the mean fractional increase in channels above the value specified by Eq. 74a is represented by the quantity [symbol] κ_{B} [symbol] , i.e. [symbol] W [symbol] ={1+ [symbol] κ [symbol] } [symbol] d [symbol] [symbol] h [symbol] / [symbol] δ [symbol] . The amount of extra capacity required depends upon the survivability mechanism that is implemented. In the case of shared mesh link restoration, the mean required fractional increase in capacity is approximated by, [symbol]
κ_{B} [symbol] =2/ [symbol] δ_{B} [symbol] . (74b)
The mean capacity of the backbone link is given by the product of the demand bit-rate and the mean number of channels, i.e. [symbol]
β_{B}=τW_{B} [symbol] . (75) [symbol]
d_{B} [symbol] and [symbol] δ_{B} [symbol] , which appear in Eq. 74, are given by Eqs. 62 and 72a, respectively. The variable [symbol] h_{B} [symbol] is the mean number of hops across the backbone network between core nodes and for nominally planar networks and location-independent demand is well approximated by, [symbol]
h_{B} [symbol] =[(N_{C}−2)/( [symbol] δ_{B} [symbol] −1)]^{1/2}. (76)
The variances of these quantities may be estimated by using the results of the general formulation. Note, the magnitude of the values of [symbol] W_{B} [symbol] and [symbol] β_{B} [symbol] will influence whether it is advantageous to introduce another layer, eg. SONET/SDH level or wavelength layer, in order to manage the traffic.

b. Regional

The network demands carried on the regional links connecting the satellite nodes and the core nodes include both intra-regional demands and extra-regional demands, as the latter must be routed between the satellite nodes and regional core node to access the backbone network. Recognizing this, the mean number of network demands on a regional link [symbol] W_{R} [symbol] may be written as, [symbol]
W_{R}=W_{IR}+W_{ER} [symbol] . (77)
where [symbol] W_{IR} [symbol] and [symbol] W_{ER} [symbol] are the mean numbers of intra-regional (IR) and extra-regional (ER) demands, respectively. For network survivability the fractional increase in capacity required on the regional links above the value specified by Eq. 77 is represented by the quantity [symbol] κ_{R} [symbol] . In the case of shared mesh link restoration, the mean required fractional increase in capacity is approximated by [symbol]
κ_{R} [symbol] =2/ [symbol] δ_{R} [symbol] . (74b)
The corresponding mean capacity required of a regional link is [symbol]
β_{R}=τW_{R} [symbol] . (78)
The mean number of inter-regional demands contributing to the sum in Eq. 77 may be expressed as [symbol]
W_{IR}=d_{X}h_{IR} [symbol] / [symbol] δ_{R} [symbol] . (79a) [symbol]
d_{X} [symbol] and [symbol] δ_{R} [symbol] , which appear in Eq. 79a, are given by Eqs. 59b and 71b, respectively. The variable [symbol] h_{IR} [symbol] is the mean number of hops of the demands among the satellite nodes within a region. Two common scenarios for routing the regional traffic may be distinguished. In one case demands are routed directly between nodes within a region on near shortest hop paths. [symbol] h_{IR} [symbol] may be approximated for this case by, [symbol]
h_{IR} [symbol] =[(N_{X}−1)/( [symbol] δ_{R} [symbol] −1)]^{1/2}, (79b)
where [symbol] N_{X} [symbol] is given by Eq. 4 and [symbol] δ_{R} [symbol] is given by Eq. 71b. In another case the traffic demands between nodes within a region are routed via the regional core node. This backhaul architecture effectively doubles the number of hops between regional node pairs and so the mean number of hops is therefore approximately, [symbol]
h_{IR} [symbol] ≅2[(N_{X}−1)/( [symbol] δ_{R} [symbol] −1)]^{1/2}. (79c)
A tradeoff between these two options for routing the regional demands is in the resources required for transmission and bandwidth management. While the backhaul scenario requires essentially twice the transmission capacity, it only requires bandwidth management resources at the core nodes. However, usually the bandwidth management costs are a small fraction of the transmission costs, and if so the direct routing of the regional traffic is expected to provide the lower cost solution.

Next the mean number of extra-regional demands [symbol] W_{ER} [symbol] that contribute to the mean number of demands appearing on a regional link (Eq. 77) is determined as, [symbol]
W_{ER}=d_{ER}h_{ER} [symbol] / [symbol] δ_{R} [symbol] , (79d)
where the mean number of extra-regional demands terminating at a node is [symbol]
d_{ER}=d_{S}−d_{X} [symbol] (79e)
with [symbol] d_{S} [symbol] given by Eq. 8 and [symbol] d_{X} [symbol] given by Eq. 59b. The mean number of hops between a satellite node and its corresponding core node is [symbol]
h_{ER} [symbol] =[(N_{X}−1)/( [symbol] δ_{R} [symbol] −1)]^{1/2}, (79f)
which the reader will observe is identical to the form of □h_{IR}□, assuming the regional demands are directly routed within a region (Eq. 79b), i.e. not backhauled. Consequently, if the intra-regional demands are chosen to be directly routed, which places the least capacity requirement on the regional links, then the total number of demands on a regional link simplifies to [symbol]
W_{R}=d_{S}h_{R} [symbol] / [symbol] δ_{R} [symbol] , (79g)
where [symbol] δ_{S} [symbol] is given by Eq. 8. and [symbol] h_{R} [symbol] is given by Eq. 79b/79f. (As an aside, when considering architectures with N_{S}<N_{C}, it is useful to replace the 2 that appears in the argument of the square-root for the approximation for the number of hops in Eqs. 79b, 79c and 79f with unity. This permits a smooth transition to the limiting configuration of N_{C}=N.)

As a second basic illustration of the model, the mean number of demands, or traffic, carried on a regional link is compared to the corresponding mean value on a backbone link by computing the ratio [symbol] W_{R} [symbol] / [symbol] W_{B} [symbol] using Eqs. 74 and 79g. Considering the case when the populations of all the nodes are identical and also [symbol] δ_{R} [symbol] = [symbol] δ_{B} [symbol] = [symbol] δ [symbol] , it can be observed for N>50 that [symbol] W_{R} [symbol] / [symbol] W_{B} [symbol] decreases as N_{C} increases and for N_{C}≦20 that [symbol] W_{R} [symbol] / [symbol] W_{B} [symbol] ≦1/5.

As a third illustration, changes of the mean required capacity on a backbone link [symbol] W_{B}(N_{C}) [symbol] |_{N} are observed as the number of core nodes N_{C} is varied for a fixed number of nodes N. Again the case under consideration assumes that the populations of all the nodes are identical and [symbol] δ_{R} [symbol] = [symbol] δ_{B} [symbol] = [symbol] δ [symbol] =3. The capacity ratio [symbol] W_{B}(N_{C}) [symbol] |_{N}/ [symbol] W_{B}(N_{C}=N) [symbol] |_{N} is largest when N_{C}≈10 for all N and that the peak value of this ratio scales roughly as √N/N_{C}′. This ratio decreases from its peak value to unity as N_{C} approaches N. For N≈100 and N_{C}≈20 to 25, it is observed that [symbol] W_{B}(N_{C}) [symbol] |_{N}/ [symbol] W_{B}(N_{C}=N) [symbol] |_{N}≅1.8. Note too for nominally planar networks serving a fixed geographic area (and by implication fixed mean demand distance) that the mean distance between core node scales as 1/√N. In this way the backbone network serves as a high-capacity, ultra-long-distance transport system.

7. Ports on Cross-Connects

The mean number of ports [symbol] P_{C} [symbol] and total capacity required of a cross-connect at the core nodes may be evaluated using the same procedure described above. For the present, it is noted that the number of working line-side ports (backbone plus regional, but omitting add/drop at the core site and not including restoration capacity) is given by, [symbol]
P_{CI} [symbol] = [symbol] δ_{B}W_{B} [symbol] + [symbol] δ_{R}W_{R}=d_{B}h_{B}+d_{S}h_{R} [symbol] , (80)
where [symbol] d_{S} [symbol] , [symbol] d_{B} [symbol] , [symbol] h_{R} [symbol] , and [symbol] h_{B} [symbol] are given by Eqs. 8, 62, 76, and 79, respectively. The corresponding capacity [symbol] X_{CI} [symbol] in units of Gbps is obtained by multiplying the value of [symbol] P_{CI} [symbol] by the channel bitrate τ, Eq. 65.
Network Cost and Architecture Optimization

The Network Global Expectation Model for network costs is based upon the concept that the total cost of the network resources to support a given traffic demand may be expressed rigorously in terms of the mean values of the required quantities and capacities of the constituent components (network elements) together with the corresponding equipment cost structures. Here the model is applied to illustrate the capability and utility of this analytic methodology to explore the characteristics, design options, and optimization of the two-tier network architecture described in the preceding sections. For the present purpose, the scope of the analysis is limited to the cost of the transmission line systems. It should be noted, however, that sufficient details have been provided here on single-tier, survivable networks to readily permit the inclusion of the costs of the network elements for bandwidth management (eg. cross-connects and/or data routers.)

For the two-tier network, the total cost of the transmission equipment, C_{TRANS}, may be partitioned into the sum of the costs of transmission for the regional and backbone networks, which is denoted as C_{R} and C_{B}, respectively, and so one can write,
C_{TRANS}=C_{R}+C_{B} (81)
In as much as the two-tier model has been formulated in such a way that the fixed total number of nodes N may be divided into a set of core and satellite nodes with a variable number of core nodes, it is expected that the relative costs of the regional and core nodes and total network cost will also vary as the number of core nodes, N_{C}, is changed. Following the Network Global Expectation Model, the regional and backbone costs may be written as,
C_{R}=L_{R}C_{R} [symbol] (82a)
and
C_{B}=L_{B}C_{B} [symbol] , (82b)
where L_{R} and L_{B} are the number of transmission links of the regional and backbone networks as specified by Eqs. 71a and 72c, and the quantities [symbol] c_{R} [symbol] and [symbol] c_{B} [symbol] are the average costs of the respective links.

The average cost of a link depends upon the required transmission capacity and reach (length) and the system cost structure. Here, for the purpose of illustration, rudimentary, pedagogical cost structures are considered for two options for the regional and backbone transmission systems that mimic aspects of an evolutionary network upgrade scenario. It is presumed that the system uses both a new generation system for the backbone and an existing earlier generation system and infrastructure for the regional networks. For the cost structure of the earlier generation system, a nearly ideal, ‘pay-as-you-grow’ cost structure is adopted wherein the system cost is directly proportional to the capacity and reach. Assuming this system is used in the regional networks, it is possible to write, [symbol]
c_{R} [symbol] =γ_{R} [symbol] β_{R}s_{R} [symbol] (1+ [symbol] κ_{R} [symbol] ), (83a)
where [symbol] β_{R} [symbol] (Eq. 78) is the mean required transmission capacity on a regional link, [symbol] s_{R} [symbol] (Eq. 73a) is the mean length of a regional link, γ_{R} is a cost coefficient, and [symbol] κ_{R} [symbol] is the mean fractional increase above the working capacity to implement survivability (eg. 1+1 protection or shared link or path restoration). For shared link restoration the mean extra working capacity is approximated by [symbol] κ_{R} [symbol] =2/ [symbol] δ_{R} [symbol] . If cost is counted in dollars, and capacity and distance are measured in units of Gbps (gigabits per second) and km, respectively, then γ_{R} has units of $/Gbps/km.

A form similar to Eq. 83a is assumed for the cost structure of the new generation system for the backbone network with the modification that the incremental cost for capacity and reach decreases as the capacity and reach are increased, such as is the case with many goods and services. Such a cost structure is indicative of a system that includes a number of fixed costs, i.e. costs that are independent of the capacity and reach, which are increasingly amortized as the utilization of the system is increased. To explore the optimization of the two-tier network, the cost of the new system for a backbone link is assumed to be reduced as the product of mean capacity and mean distance increases relative to the required mean capacity and mean distance of a link for the single-tier solution for the network of all N nodes. Mathematically the mean cost of a backbone link then takes the form [symbol]
c_{B} [symbol] =γ_{B} [symbol] β_{B}s_{B} [symbol] (1+ [symbol] κ_{B} [symbol] )ε^{log}^{₂}^{[β}^{_{B}}^{s}^{_{B}}^{/(β}^{_{N}}^{s}^{_{N}}^{)]}, (83b)
where [symbol] β_{B} [symbol] (Eq. 75) is the mean required transmission capacity on a backbone link, [symbol] s_{B} [symbol] (Eq. 73b) is the mean length of a backbone link, γ_{B} is a cost coefficient, [symbol] κ_{B} [symbol] is the mean fractional increase above the working capacity to implement survivability, and [symbol] β_{N} [symbol] and [symbol] s_{N} [symbol] are the capacity and reach required for a single-tier solution for the network. As indicated above, for shared link restoration the mean extra working capacity for the backbone is approximated by [symbol] κ_{B} [symbol] =2/ [symbol] δ_{B} [symbol] . For specificity, under low utilization of the new system, the incremental cost for capacity and reach is identical to the older generation system, which has constant incremental cost independent of the utilization. In this case, the cost coefficient γ_{B} for the new system appearing in Eq. 83b is chosen to be the same cost coefficient that appears in Eq. 83a, i.e. γ_{B}=γ_{R}=γ.

The parameter ε in Eq. 83b is a dimensionless coefficient that specifies the fraction by which the unit cost for transmitting bits over distance of the new system (i.e., backbone transmission system cost) is reduced for each doubling of the capacity-distance product relative to the single tier transmission system requirements. Such a rudimentary cost structure mimics the aspect of decreasing cost at higher volume deployment, such as is common in production experience curves. However, the reader is cautioned that this cost structure is deliberately intended here only for the purpose of illustrating the capability of the model and the possibilities for cost optimization of the transmission equipment in two-tier architectures. In particular, the cost structures of Eqs. 83a&b have the advantage that the functional forms are independent of technology and the particular system realizations, and so highlight the dependency on the network architecture. It is noted that in the case of production experience curves, values of ε˜0.9 are considered a soft dependency, values of ε˜0.7 are considered typical, and values of ε˜0.5 are clearly aggressive and unsustainable.

As a reference cost for the two-tier network, it is useful to consider the cost of the single-tier network, for which all the N nodes are peers, i.e. N_{C}=N, and the new generation of system is used on all of the links. Using Eq. 83b the cost structure of the links for the single-tier network reduces to [symbol]
c_{N} [symbol] =γ_{B} [symbol] β_{N}s_{N} [symbol] (1+ [symbol] κ_{B} [symbol] ), (83c)
as by construction the cost reduction factor is unity in this case. Using this reference cost structure, the cost calculations for the two-tier network can be presented as the ratio R of the two-tier cost to the cost of a single-tier network. Mathematically, this becomes,
R(T,N_{C})|_{N}=C_{TRANS}(T,N_{C})|_{N}/C_{TRANS}(T,N_{C}=N)|_{N}, (84)
where the costs, and hence the ratio, are in general explicitly made a function of the total network traffic T.

For the present illustrative purpose, it is assumed that the variances and covariances of the degrees of nodes and node populations are relatively small and may be ignored, i.e. the dominant requirements are well represented by the lead terms, which correspond to a uniform demand model. Further, the mean values of the populations and degrees of nodes of the backbone and regional nodes are assumed to be identical. With the problem as stated, the single-tier reference cost to serve a total network traffic T may be calculated using Eq. 83c and multiplying by the number of links, L. When N is large compared to unity the single-tier reference cost is approximately given by,
C_{TRANS}(T,N_{C}=N)|_{N}≈γT√A(1+ [symbol] κ [symbol] )/√ [symbol] δ [symbol] . (85)
Similarly, Eqs. 81-83 are used to determine the regional and backbone costs for the two-tier architecture. When both N and N_{C} are large compared to unity, using the results presented above, the regional and backbone contributions to the cost of the two-tier architecture to serve traffic T are derived as,

$$\begin{matrix}\begin{matrix}{C}_{TRANS} ( T , {N}_{C} ) {\vert}_{R} ≅ \{ γ T \sqrt{A} ( 1 + 〈 κ 〉 ) / \sqrt{〈 δ 〉} \} \\ {[ 〈 δ 〉 ( N - {N}_{C} ) / ( {NN}_{C} ) ]}^{1 / 2}\end{matrix} \\ and & ( 86 a ) \\ \begin{matrix}{C}_{TRANS} ( T , {N}_{C} ) {\vert}_{B} ≅ \{ γ T \sqrt{A} ( 1 + 〈 κ 〉 ) / \sqrt{〈 δ 〉} \} \\ \{ 1 - 〈 δ 〉 / {N}_{C} \} {ɛ}^{{log}_{2} [ 〈 {β}_{B} 〉 〈 {s}_{B} 〉 / ( 〈 {β}_{N} 〉 〈 {s}_{N} 〉 ) ]} .\end{matrix} & ( 86 b )\end{matrix}$$

The ratio of costs is computed as specified in Eq. 84. If the approximations of Eq. 85 and 86 are used to gain insight into the dependencies, then the ratio R(T,N_{C})|_{N} may be reduced to
R(T,N_{C})|_{N}≅{ [symbol] δ [symbol] (N−N_{C})/(NN_{C})}^{1/2}+{1− [symbol] δ [symbol] /N_{C}}ε^{log}^{₂}^{[β}^{_{B}}^{s}^{_{B}}^{/(β}^{_{N}}^{s}^{_{N}}^{)]}. (87)

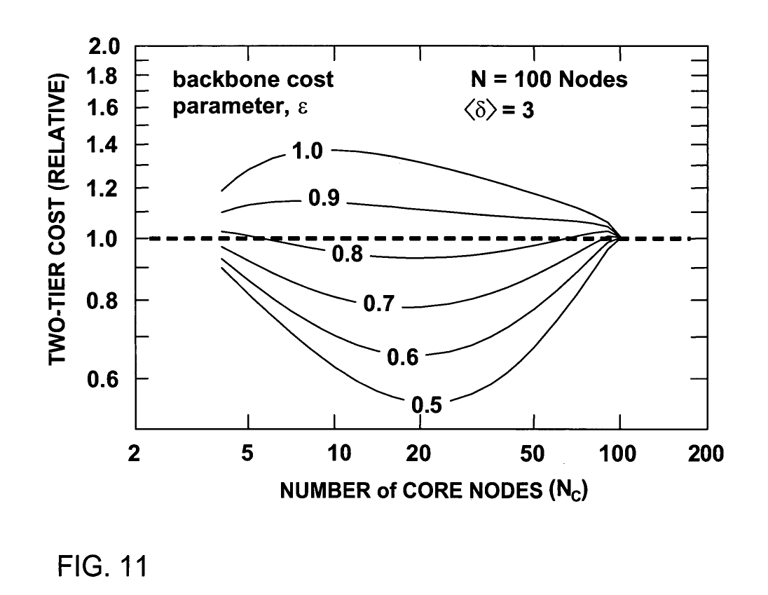

The ratio of the two-tier cost to the reference single-tier cost is graphed as a function of the number of nodes in the backbone network, N_{C}, in FIG. 11 considering the rate of cost reduction with the capacity-distance product, ε, as a parameter. For the calculations presented in the figure, the number of nodes is chosen as N=100, but the assumptions that N and N_{C} are large compared to unity have not been introduced. A person skilled in the art will appreciate that the analytic approach used here easily permits the value of ε and the other variables to be varied to explore the sensitivities of the total transmission cost. It can be seen from the figure that as N_{C} approaches N and the network becomes increasingly like a single-tier network, the cost ratio approaches unity, as expected. As N_{C} approaches N_{C}=4, which is the smallest number of nodes possible for a survivable network with mean degree of node [symbol] δ [symbol] =3, the cost ratio is close to unity. This is because for a very small number of core nodes the majority of the demands are serviced within the regional networks, which use a transmission system that is assumed to have a cost profile similar to the new system used in the backbone network at light load. For intermediate values of the number of core nodes, it is observed that the total network transmission cost for the two-tier architecture exhibits a local maximum or minimum relative to the single-tier cost. This is because of the interaction of several factors. It should be noted that as the number of core nodes is increased from N_{C}=4, the backbone network carries an increasing fraction of the total network traffic, the number of links in the backbone increases as the number of core nodes increases—which lessens the load per link for fixed demand, and the incremental cost of transport using the new generation of system decreases with increased utilization. A minimum in the ratio of the total network transmission cost is predicted by the Network Global Expectation Model method when the number of core nodes is approximately N_{C}≈20-25. This result is in qualitative agreement with the reported data of an independent calculation of the cost for two-tier networks. The calculations shown in FIG. 11 also illustrate how the present model may be used to establish the criteria on the cost-structures for which the two-tier architecture is the lower cost solution.

An analytic framework for the evaluation of the requirements and costs of two-tier and multi-tier architectures for communication networks has been presented using the Network Global Expectation Model. Additionally, it has been illustrated how this statistical methodology may be extended to the case of non-uniform traffic by explicitly treating the case of population-dependent demand. The analytic approach presented above achieves results with useful accuracy very quickly using only very modest computational resources, and so enables the investigation of an extremely wide range of architectural and technology options for networks of arbitrary size. As an example application, the method has been used to optimize the partitioning of a continental-scale, communication transport network into regional and backbone mesh networks to minimize the total transmission cost relative to a single-tier solution. The analytic approach also provides valuable insight into the underlying, critical dependencies of two-tier architectures.

Refinement of Cost Structure and Evolution of Network Cost

In alternate embodiments of the present invention, the cost structure may be modified to account for the real-world implementation limits affecting maximum system capacities. Examples of such constraints are the maximum number of channels or wavelengths an optical line system is engineered for, or the maximum throughput of a switch fabric or backplane in the case of a cross-connect or router. Such hard bounds to network element capacity occur for any physical realization and have the effect of introducing quantum steps in the cost structure. When required capacities exceed the system capabilities, generally additional systems are deployed in parallel, and additional corresponding startup costs are incurred. Having developed a framework for the evaluation of the variances and distribution functions of key network variables earlier herein, a foundation has been provided to estimate the number of additional systems that are required given the network requirements and system bounds. Note too that in some instances the result of introducing these additional systems is to effectively increase the number of links or nodes of the network.

Furthermore, in alternate embodiment of the present invention, the Network Global Expectation Model of the present invention may be used for sensitivity analyses of the dependency of requirements and costs upon primary and secondary network and network element variables. The Network Global Expectation Model may also be used to compute the constituent and total network costs as a function of time. This requires only a model for how the total network traffic, number of nodes and links, and technology costs are expected to change. Some models for estimating how the total network traffic, number of nodes and links, and technology costs are expected to change are known in the art.

As previously mentioned, although the concepts of the present invention are being described herein with respect to communication networks, the concepts of the present invention may be applied to other networks and systems, such as power and commodity distribution and transportation systems.

The operations of the present invention may be performed by a general purpose computer that is programmed to perform various operational calculations and functions in accordance with the present invention. In addition, the calculations and functions of the present invention can be implemented in hardware, for example, as an application specified integrated circuit (ASIC). As such, the process steps described herein are intended to be broadly interpreted as being equivalently performed manually by a user or by software, hardware, or a combination thereof.

Furthermore, in an alternate embodiment of the present invention, the calculations, equations, and operations of the present invention herein may be loaded into the memory of a general purpose computer, along with instructions, for performing the operations and functions of the present invention. As such, the present invention comprises a computer program product.

Appendix

1. Mean, Variance, and Co-Variance

The mean value of the set {q} of m values for the network variable q, denoted [symbol] q [symbol] , the variance of q, denoted σ²(q), and standard deviation of q, denoted σ(q), are defined by,

$$\begin{matrix}〈 q 〉 ≡ \frac{1}{m} {\sum }_{i}^{m} {q}_{i} , & ( A .1 .1 ) \\ {σ}^{2} ( q ) ≡ \frac{1}{m} {\sum }_{i}^{m} {( {q}_{i} - 〈 q 〉 )}^{2} , & ( A .1 .2 )\end{matrix}$$

which may be rewritten as
σ²≡q²−q². (A.1.3)

The covariance of the variables p and q, σ(p,q) is defined as

$${σ}^{2} ( p , q ) ≡ \frac{1}{m} {\sum }_{i}^{m} ( {p}_{i} - 〈 p 〉 ) ( {q}_{i} - 〈 q 〉 ) , \qquad ( A .1 .4 )$$

which may be written as
σ²(p,q)≡ [symbol] pq−pq. (A. 1.5)
2. Population Based Demand Model

Let the total population be p and let the population be divided into two groups with populations pₐ and p_{b}. Assuming uniform unit demand among the members of the population, the total number of two-way demands is
D=p(p−1)/2 (A.2.1)
The number of demands within the first group is
Dₐ=pₐ(pₐ−1)/2 (A.2.2a)
and the number of demands within the second group is
D_{b}=p_{b}(p_{b}−1)/2 (A.2.2b)
Hence, the number of demands between the two groups is
D_{ab}=D−Dₐ−D_{b} (A.2.3a)

Substituting for D, Dₐ and D_{b} using A.1 and A.2 yields
D_{ab}=pₐp_{b}, (A.2.3b)
i.e. the number of demands between the two groups is proportional to the product of the respective populations.

While the forgoing is directed to various embodiments of the present invention, other and further embodiments of the invention may be devised without departing from the basic scope thereof. As such, the appropriate scope of the invention is to be determined according to the claims, which follow.

1. A method for quantifying the needs and costs of a network, the network including a plurality of N nodes interconnected by a plurality of L links, the method comprising the steps of:
arranging the network hierarchically into at least two tiers by:
dividing the N nodes into at least first and second sets: the first set including N_{C} core nodes as a first tier and the second set including N_{S} satellite nodes as a second tier, where N_{S}=N−N_{C}; and
defining, for each core node, a region including the particular core node and those satellite nodes connected to the particular core node; and
determining quantities of required network variables using closed-form mathematical expressions for network-wide expectation values for mean quantities of the network variables.

2. The method as defined in claim 1 further comprising:
determining variations of a minimum number of required network variables using said mathematical expressions.

3. The method as defined in claim 2 wherein the determining step further comprises selecting the required network variables from the group consisting of network elements, subsystems and components.

4. The method as defined in claim 3 further comprising inputting information, for use in the mathematical expressions, selected from the group consisting of a number of network nodes, a number of links and a number of demands in said network.

5. The method as defined in claim 4 further comprising the step of calculating a local value of the number of demands appearing on a link or carried on a means of transmission.

6. The method as defined in claim 5 wherein said demands comprise at least one demand selected from the group consisting of uniform demands, random demands, non-uniform demands, and distance dependent demands, wherein the non-uniform demands include at least population-dependent, location-independent demands.

7. The method as defined in claim 1 further comprising the step of calculating a mean value of a number of transmission subsystems.

8. The method as defined in claim 7 further comprising the step of calculating a variance of the number of transmission subsystems.

9. The method as defined in claim 1 further comprising the step of calculating at least one of a global mean value and a variance of a number of demands present at a node.

10. The method as defined in claim 9 wherein said demands comprise at least one demand selected from the group consisting of uniform demands, random demands, non-uniform demands, and distance dependent demands, wherein the non-uniform demands include at least population-dependent, location-independent demands.

11. The method as defined in claim 1 further comprising the step of calculating a global mean value of extra capacity necessary for network survivability.

12. The method as defined in claim 1 further comprising the step of calculating a local value of extra capacity required on a link for network survivability

13. The method as defined in claim 1 further comprising the step of calculating a cost of transmission of demands across the network.

14. The method as defined in claim 1 further comprising the step of calculating a cost of bandwidth management of demands across the network.

15. The method as defined in claim 1 further comprising the step of calculating a ratio of cost of electronic and optical bandwidth management.

16. The method as defined in claim 1 further comprising the step of calculating a ratio of cost of transmission and bandwidth management.

17. The method as defined in claim 1 further comprising the step of calculating a cost of the network.

18. The method as defined in claim 1 wherein the determining step includes the step of calculating [symbol]
D_{SR} [symbol] ≅½(1−1 [symbol] N_{SR} [symbol] ){ [symbol] N_{SR} [symbol] ²p_{S} [symbol] ²+σ²(P_{SR})}/ [symbol] δ_{R} [symbol] , [symbol]
D_{SC}=N_{SR}p_{S}p_{C} [symbol] +σ²(P_{SR},p_{C}),
D_{R}/D≅δ_{R}/N_{C}, and
D_{B}/D≅1− [symbol] δ_{R}/N_{C},
where [symbol] D_{SR} [symbol] is the average number of unique two-way demands among satellite nodes in the regions, [symbol] D_{SC} [symbol] is the average number of unique two-way demands between the core node and the satellite nodes in a region, [symbol] N_{SR} [symbol] is the average number of satellite nodes in the regions, [symbol] p_{S} [symbol] is the average population at the satellite nodes, [symbol] p_{C} [symbol] is the average population at the core nodes, [symbol] δ_{R} [symbol] is the mean degree of the satellite nodes in a region, D_{R}/D is a fraction of network traffic carried in the regions, D_{B}/D is a fraction of the network traffic carried among the core nodes in a backbone network, σ²(P_{SR}) is the variance of the population of the satellite nodes, and σ²(P_{SR},p_{C}) is the covariance of the population of the satellite nodes with the core node population.

19. The method as defined in claim 1 wherein the mathematical expressions require inputs selected from the group consisting of mean value of populations served by nodes in the network, variance of populations served by nodes in the network, and covariance of populations served by nodes in the network.
